(19) United States
(12) Patent Application Publication
(10) Pub. No.: US 2022/0058212 A1
(43) Pub. Date: Feb. 24, 2022

(54) METHODS, SYSTEMS, APPARATUSES, AND DEVICES FOR FACILITATING DOCUMENTING JOURNEYS OF PHYSICAL OBJECTS

(71) Applicant: Hanif Janmohamed, Vancouver (CA)

(72) Inventor: Hanif Janmohamed, Vancouver (CA)

(21) Appl. No.: 17/407,834

(22) Filed: Aug. 20, 2021

Related U.S. Application Data
(60) Provisional application No. 63/068,286, filed on Aug. 20, 2020.

(51) Int. Cl. G06F 16/29; G06Q 10/08; G06Q 30/06

(52) U.S. Cl. CPC G06F 16/29; G06Q 30/0601; G06Q 10/0833

(57) ABSTRACT

A method and system for facilitating documenting journeys of physical objects is provided. Further, the method may include a step of receiving an identifier associated with a physical object from a device, identifying the physical object based on the identifier, retrieving a physical object historical data associated with the physical object based on the identifying, receiving physical object data associated with the physical object from the device, analyzing the one or more physical object data and the physical object historical data, determining a tracking parameter for tracking a journey by the physical object based on the analyzing, generating a journal of the physical object using the physical object data and the physical object historical data based on the tracking parameter, and storing the physical object data and the journal.

The current application claims a priority to the U.S. provisional patent application serial number 63/068,286 filed on Aug. 20, 2020.

### FIELD OF THE INVENTION

Generally, the present disclosure relates to the field of data processing. More specifically, the present disclosure relates to methods, systems, apparatuses, and devices for facilitating documenting journeys of physical objects.

### BACKGROUND OF THE INVENTION

The field of data processing is technologically important to several industries, business organizations, and/or individuals.

Currently, many social media platforms exist that allow individuals to check in to one or more locations and display additional media such as pictures and videos pertaining to the location that the individuals may have checked in. Further, individuals can view virtual timelines that display the digital content posted by the individuals in chronological order.

Existing techniques for facilitating documenting journeys of physical objects are deficient with regard to several aspects. For instance, current technologies do not facilitate tracking of the location of a physical object and display a journey of the physical object on a map. Furthermore, current technologies do not allow individuals to gift and pass on the physical objects to other individuals and track the location of the physical object and display the location and journey of the object. Moreover, current technologies do not allow individuals to upload digital content with respect to the one or more tracked locations of the physical object being tracked and display the uploaded digital content in the form of a journal.

Therefore, there is a need for methods, systems, apparatuses, and devices for facilitating documenting journeys of physical objects that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating documenting journeys of physical objects, in accordance with some embodiments. The method may include a step of receiving, using a communication device, one or more identifier associated with one or more physical object from one or more device. Further, the method may include a step of identifying, using a processing device, the one or more physical object based on the one or more identifier. Further, the method may include a step of retrieving, using a storage device, one or more physical object historical data associated with the one or more physical object based on the identifying. Further, the method may include a step of receiving, using the communication device, one or more physical object data associated with the one or more physical object from the one or more device. Further, the method may include a step of analyzing, using the processing device, one or more of the one or more physical object data and the one or more physical object historical data. Further, the method may include a step of determining, using the processing device, one or more tracking parameter for tracking a journey by the one or more physical object based on the analyzing. Further, the method may include a step of generating, using the processing device, one or more journal of the one or more physical object using one or more of the one or more physical object data and the one or more physical object historical data based on the one or more tracking parameter. Further, the method may include a step of storing, using the storage device, the one or more physical object data and the one or more journal.

Further disclosed herein is a system for facilitating documenting journeys of physical objects, in accordance with some embodiments. The system may include a communication device, a processing device, and a storage device. Further, the communication device may be configured for performing a step of receiving one or more identifier associated with one or more physical object from one or more device. Further, the communication device may be configured for performing a step of receiving one or more physical object data associated with the one or more physical object from the one or more device. The processing device may be communicatively coupled with the communication device. Further, the processing device may be configured for performing a step of identifying the one or more physical object based on the one or more identifier. Further, the processing device may be configured for performing a step of analyzing one or more of the one or more physical object data and one or more physical object historical data. Further, the processing device may be configured for performing a step of determining one or more tracking parameter for tracking a journey by the one or more physical object based on the analyzing. Further, the processing device may be configured for performing a step of generating one or more journal of the one or more physical object using one or more of the one or more physical object data and the one or more physical object historical data based on the one or more tracking parameter. The storage device may be communicatively coupled with the processing device. Further, the storage device may be configured for performing a step of retrieving the one or more physical object historical data associated with the one or more physical object based on the identifying. Further, the storage device may be configured for performing a step of storing the one or more physical object data and the one or more journal.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating documenting journeys of physical objects, in accordance with some embodiments.

FIG. 4 is a continuation flow chart of FIG. 3.

FIG. 5 is a flow chart of the method for facilitating documenting journeys of physical objects in which the method may include arranging one or more of the one or more digital content and the one or more historical content based on the one or more tracking parameter, in accordance with some embodiments.

FIG. 6 is the continuation flow chart of FIG. 5.

FIG. 7 is the flow chart of the method for facilitating documenting journeys of physical objects in which the method may include plotting one or more path traveled by the one or more physical object on one or more map based on the one or more location, in accordance with some embodiments.

FIG. 8 is the continuation flow chart of FIG. 7.

FIG. 9 is a flow chart of the method for facilitating documenting journeys of physical objects in which the method may include transmitting the one or more recommendation to the one or more device, in accordance with some embodiments.

FIG. 10 is a flow chart of a method for facilitating documenting journeys of physical objects in which the method may include registering the one or more physical object for the documenting of the journey of the one or more physical object, in accordance with some embodiments.

FIG. 11 is a flow chart of a method for facilitating documenting journeys of physical objects in which the method may include transmitting the one or more recommendation to the one or more device, in accordance with some embodiments.

FIG. 12 is a flow chart of a method for facilitating documenting journeys of physical objects in which the method may include transmitting the ownership acknowledgment to one or more devices associated with one or more members associated with the network, in accordance with some embodiments.

FIG. 13 is a block diagram of a system for facilitating documenting journeys of physical objects, in accordance with some embodiments.

FIG. 14 is a flowchart of a method to facilitate the tracking of the location of a physical object to display a journey of the physical object on a map in the form of a journal, in accordance with some embodiments.

FIG. 15 is a top view of a stone associated with the disclosed system for facilitating tracking the location of a physical object to display a journey of the physical object on a map in the form of a journal, in accordance with some embodiments.

FIG. 16 is a screenshot of a user interface of a software platform associated with the system to facilitate tracking the location of a physical object to display a journey of the physical object on a map in the form of a journal, in accordance with some embodiments.

FIG. 17 is a screenshot of a user interface of the software platform of the system to facilitate tracking the location of a physical object to display a journey of the physical object on a map in the form of a journal, in accordance with some embodiments

FIG. 18 is a flow diagram of a method to facilitate tracking the location of a physical object to display a journey of the physical object on a map in the form of a journal, in accordance with some embodiments.

FIG. 19 is a continuation flow diagram of FIG. 18.

FIG. 20 is a flow diagram of a method to facilitate tracking the location of a physical object to display a journey of the physical object on a map in the form of a journal, in accordance with some embodiments.

FIG. 21 illustrates an apparatus drilling the depression into a surface of the stone, in accordance with some embodiments.

FIG. 22 illustrates an apparatus for inserting tags and protective acrylic disc in the stone, in accordance with some embodiments.

FIG. 23 is a top view of a stone with tags and protective acrylic disc, in accordance with some embodiments.

FIG. 24 is a flow diagram of a method to facilitate tracking the location of a physical object to display a journey of the physical object on a map in the form of a journal, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating documenting journeys of physical objects, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g.

username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), and an environmental variable sensor (e.g. temperature sensor, humidity sensor, pressure sensor, etc.) associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating documenting journeys of physical objects. Further, the disclosed system may be configured to facilitate tracking the location of a physical object to display a journey of the physical object on a map in the form of a journal. Further, the disclosed system may be configured to communicate with one or more user devices. The one or more user devices may include one or more mobile devices such as, but not limited to, smartphones, computer tablets, laptops, and so on. The one or more user devices may include a communication device configured to communicate over a communication network such as, but not limited to, a cellular network, a satellite network, a personal area network, Bluetooth, Internet, and so on. Further, the disclosed system may be configured to communicate with one or more physical objects. The one or more physical objects may include one or more embedded tags such as, but not limited to, an optical code, RFID tag, or NFC tag. The one or more embedded tags may be used to retrieve information particular to the one or more physical objects such as, but not limited to the serial number, location, associated media content, and so on of the one or more physical objects. Further, although the present invention is described with the one or more physical objects embodied, and referred as one or more stones, the one or more one physical objects may be embodied in one or more physical forms such as memorabilia, or souvenirs in one or more other embodiments of the present invention. Accordingly, the one or more user devices communicating with an online platform, associated with the disclosed system, may be used to scan the one or more tags embedded in the one or more stones and retrieve information such as the serial number, location, associated media content, and so on of the one or more stones. Further, the disclosed system may allow the one or more one or more users to create user profiles on the online platform. The one or more user profiles may contain personal information such as the name, age, location, etc. of the one or more users. Further, the user profiles may include additional information such as information associated with one or more stones of the users. Information associated with one or more stones of the users may include information such as the serial numbers of the one or more stones, and additional data retrieved from the stones such as location, and media associated with the one or more stones. Further, the disclosed system may allow the one or more users to create and associate digital content such as one or more videos, pictures, text documents, etc. with the one or more stones associated with the user profiles of the one or more users. Further, the disclosed system may track the location of the one or more stones associated with the accounts of the one or more users through one or more user devices used by the one or more users to scan the one or more tags embedded in the one or more stones. Accordingly, based on the movement of the one or more stones, as tracked through the one or more of the one or more user devices, a path displaying the one or more journeys of the one or more stones may be created.

Further, the one or more embedded tags may be used to retrieve information particular to the one or more physical objects such as, but not limited to the serial number, location, associated media content, and so on of the one or more physical objects. The one or more physical objects may include one or more electronic devices, or different types of objects such as memorabilia, souvenirs, or even stones. Further, although the present invention is described with the one or more physical objects embodied, and referred to as one or more stones, the one or more physical objects may be embodied in one or more physical forms such as memorabilia, or souvenirs in one or more other embodiments of the present invention.

Further, the disclosed system may allow the digital content such as the one or more videos, pictures, text documents associated with the one or more stones associated with the user profiles of the one or more users to be saved in the form of a journal. For instance, the one or more users may travel to one or more locations with the one or more stones associated with the user profiles of the one or more users. Further, the one or more users may capture and create digital content such as one or more pictures, videos, and text documents such as blogs associated with the one or more travels undertaken by the one or more users. Accordingly, the digital content created by the one or more users may be associated with the one or more stones of the one or more users and saved as one or more journals.

Further, in an embodiment, the digital content created by the one or more users associated with the one or more stones of the one or more users may be incorporated in the one or more saved journeys. Accordingly, one or more paths of the journeys may be saved in the one or more journals along with the digital content.

Further, Stonemaps, an exemplary embodiment of the disclosed system herein, may be associated stonemap (or stone) that may include smooth beach and river stones imprinted with a map of any location in the world. Stonemaps can be imprinted with other types of imagery or decoration—such as patterns, symbols, or photographs. The image may be imprinted onto the stone's surface using a hydrographic ink transfer process. Further, the image may be directly printed onto the stone using a UV flatbed benchtop printer. Further, the UV flatbed benchtop printer is designed to print directly onto 3D objects (such as the stone). Stonemaps are finished with a durable UV-resistant clear coating and can be serially printed as multiples of the same map, or can be customized with an individual map of any location and zoom level and map style. Further, each Stonemap is uniquely tagged with a serial number encoded onto an embedded NFC tag. Further, the serial number may be encoded onto the embedded NFC tag using the software. Further, the Stonemap may include a new tag that functions to authenticate the Stonemap. Further, the new tag may be a NTAG 424 DNA. Further, the NTAG 424 DNA is a tag designed to validate a product (such as the stone) by issuing a unique code each time the tag is scanned by a device to prevent spoofing. The tag provides more robust product authentication of the product. The NFC tag contains data consisting of a unique identifier or serial number, and a URL address that connects it to a specific URL on the Stonemaps online platform. Participants who connect to the online platform can register their Stonemap and add their content and media to its associated ‘journal’ on the Stonemaps platform. The journal is a media container or media tray, that may contain user-generated information including text, video, photos, audio, or other web-based content. Stonemap may be also geo-tracked online each time their unique URL is accessed. When a participant connects a Stonemap to the platform via a web browser, the current physical location of the connecting device is geo-tracked, and the location is logged in a database and the geo-location information is pinned on the virtual map online.

Further, the stonemap may be launched on physical journeys and geo-tracked, by being passed on as a gift to others or given to travelers from other locations. Participants along the Stonemap's journey can add their own stories to the messages, posts, and media in the Stonemap's journal. The Stonemaps platform provides ongoing notification to participants. Each time a traveling Stonemap is logged at a new location, the participants along its specific journey will receive a location update and they can visit the platform to read posts and media online.

Stonemaps may be produced in various sizes ranging from small hand-held stones to larger stones and boulders. Stonemaps may also be produced without the addition of NFC tags or serial numbers. For example, with very small Stonemaps used as jewelry, or for very large Stonemaps that may not require the geolocation feature.

The production of Stonemaps is based on an existing hydrographic ink transfer process. This process is used to transfer a 2D printed image onto a 3D irregular-shaped object through liquid immersion. The desired images are printed onto PVA film (polyvinyl alcohol) typically with a pigment-based inkjet printer, or by offset printing, and transferred onto the object through water immersion. The process is variously known as hydrographic printing, water transfer printing, or liquid immersion printing

The general production process for the Stonemap may include stone preparation—drilling. Further, depression is blind drilled into the bottom surface of a stone using a diamond drill on a drill-press fitted with a clamping assembly. The depression is made using a one two-stepped diamond drill-bit or made sequentially using two separate diamond drill-bits of different diameters. The smaller diameter depression is used during the production process, to hold a keep-nut for the attachment of a handle and production tag. The larger diameter depression is used for embedding the NFC tag, serial number, and protection cover.

Further, the production process for the Stonemap may include making a single diameter blind hole in the stone for the attachment of the handle and the final embedding of the NFC tag.

Further, the general production process for the stonemap may include stone preparation—cleaning, and priming. The drilled stones are then cleaned and degreased. The stones are prepared for the hydrographic dipping process by applying a clear, white, or colored primer that is suitable for this transfer process, such as Aqualac 35. The primer is applied to the bottom edge of the stone with an airbrush in a pattern that leaves the middle of the stone unprimed. The top and sides of the stones are then primed using a typical spray gun, and the primed stones are then stored for use.

Further, the general production process for the stonemap may include PVA Film Printing. The digital maps, and/or other digital or scanned imagery are prepared for print using a desktop computer and image processing and page imposition programs. The images are reverse printed (mirrored) onto the appropriate PVA film (blank hydrographic film) using a high-resolution pigment-based inkjet printer. If required, the PVA film is sprayed with a lacquer-based sealer to stabilize and preserve the printed image for extended storage. In the case of serial printing or large volume printing, offset printing techniques could be used.

Further, the general production process for the stonemap may include hydrographic dipping Stonemap ‘printing’ utilizes an established hydrographic dipping process to transfer the printed image from the PVA film onto the stone. The backing sheet is removed from the printed PVA film and the film is floated, print side up, in a purpose-built hydrographic dip tank. An activator compound—for example, a commercially available hydrographic activator—is sprayed onto the surface of the film, and after an appropriate length of time, the stone is pushed through the surface of the film/water, transferring the image onto the stone. The water dissolves the PVA film. The imprinted stone is rinsed in a purpose-built rinse tank to remove any remaining PVA film and activator and is placed in a drying cupboard for final air drying.

Further, the general production process for the stonemap may include stonemap Finishing. The imprinted surfaces of the Stonemaps are clear coated using a hard finish UV protective coating. The clear coatings may be ceramic-based—such as Cerakote—or other clear coatings as appropriate to provide UV protection and create a hard-durable finish.

Once cured, the handle and production tags are removed, the NFC tag is inserted. Further, a serial number is encoded onto the NFC tag. The NFC tag is encoded with the serial number and URL for the platform and the specific Stonemap, using an NFC encoder and a protective acrylic disc is pressure fitted or glued, to seal the opening and protect the tags.

Further, the general production process for the stonemap may include stonemap Packaging. The finished Stonemap is packaged along with a descriptive insert and information about the stone or location, as appropriate, and then is placed in a bag and boxed for shipping.

Research into the use of specialty inks and coatings such as phosphorescent coatings, metallic and specialty primers, heat-sensitive coatings, conductive and nano paints and inks - and the use of printing processes such as the use of eco-solvent printers and latex printers, is ongoing. Research into printing on larger and smaller stones is also ongoing. The design of the hydrographic tank is being researched to include innovation in extraction, water recycling, and filtration.

Further, the user (or people) who acquire Stonemaps can access the Stonemap platform to register, geo-locate their Stonemaps and share messages and content with others.

The Stonemaps platform provides users with a series of functionality, allowing visitors to the platform to purchase Stonemaps through the e-commerce store. Further, The Stonemaps platform may allow the visitors to compose and create custom Stonemaps. The Stonemaps platform may allow the visitors to explore public Stonemap journeys and review stories and media. The Stonemaps platform may allow the visitors to search/filter for specific data/keywords. The Stonemaps platform may allow the visitors to sign up to follow and receive location updates on specific stonemaps. The Stonemaps platform may allow the visitors to connect with other project participants and site visitors.

Further, the user who purchases a Stonemap can register their Stonemaps on the Stonemap platform and can share their content and messages for other participants, or for the benefit of those to whom they gift their Stonemaps. In the case of traveling Stonemaps, additional participants along a Stonemap's journey can also sign-up to add content to previous posts, post and share their content, and receive ongoing location updates.

Registration using existing social media platforms may be supported and may be managed in an online database. Public /private Stonemap journeys and stories can be made private or public by the original participant. Private Stonemaps can be limited to specific individuals or private groups. Public stonemaps can be accessed by anyone visiting the platform.

Stonemap journeys can be viewed as a series of sequential location pins on the interactive map or as elements along a timeline of a Stonemap's journey. Each location pin is associated with a post that can contain text and media.

Further, participants along a Stonemap's journey are automatically notified as the Stonemap makes its journey and new contributions are added. Registered site visitors can also subscribe for ongoing notifications on public Stonemaps journeys.

Further, each Stonemap is uniquely identified and can be located as an individual item on the interactive map. Stonemaps can also be associated with groups. Groups of Stonemaps can share some common associations, including a shared media tray or journal. Stonemap groups may be public or private.

Further, each Stonemap serial number is associated with a UUID in a database on the online platform. Each entry includes information about the specific Stonemap, including but not limited to production data, map data, distribution, purchase history, origin location, current location, participant-related information and references to uploaded content, and other details about the Stonemap.

When Stonemaps that are tagged with an NFC tag is activated by a participant using an NFC-enabled smartphone, the NFC tag will connect the smartphone's web browser to a specific URL, and pass the Stonemap's serial number to the Stonemaps platform. Participants may also achieve the same outcome by connecting their Stonemap by typing the project URL in a web browser using an internet-enabled device, such as a desktop computer, laptop, or tablet. When connected in this way, participants will be asked to manually enter their Stonemap's serial number and that will redirect the browser to the Stonemap's specific URL on the platform. The platform will query the connected device for location data and geo-locate the Stonemap on the interactive map. When connected via an NFC chip, the platform may query the smartphone's GPS location data to identify the current location. In the case of a web browser and serial number, the platform will use IP information and triangulation to identify the current location. Participants may be asked to confirm their current location, and the location data will be stored in the database and a location pin added to the online map.

Each Stonemap is associated with its own unique Journal on the Stonemap Platform. Journals can be made public or private. A Journal can contain text, images, video, posts, and comments. The journal can also be redirected to other online content, such as social media platforms, websites, or other web-based content. The journal allows the original poster to initiate stories and media and allows subsequent participants to add additional content. In this way. a journal can contain an aggregation of posts organized sequentially, that make up the history of the Stonemap. As a Stonemap makes its journey, its physical location is geo-tracked every time it gets logged on the platform, a new journal entry, tied to that location, is created for a new content upload, and the online map is updated to illustrate the new location.

Further, the stonemaps may be available for purchase through an online e-commerce store on the Stonemaps website, through other e-tailers such as ETSY, and be available in select high-end retail locations.

Further, the disclosed system may be configured for creating custom Stonemaps for any location in the world and can be composed and ordered online on the Stonemaps website. Further, a custom Stonemap application associated with the disclosed system may allow participants and customers to compose their own Stonemaps. Using a user-friendly interface, customers can do this by choosing the size of their preferred stone from a pick list, selecting their preferred location and zoom level from the interactive map, dragging and composing the map to frame their desired location, selecting and applying a map style from a style gallery, accepting the facsimile of their custom stonemap and commissioning the production, and entering their information and paying for their personal customized Stonemap. Further, additional map styles will be added over time and users may also be able to upload and create their map styles. Future development may support the use of other kinds of imagery, patterns, symbols, etc.

Further, stonemaps can be produced in series with maps of various locations as commemorative objects. These could include maps of cities, national parks, and specific landmarks. Stock Stonemaps will be available for purchase through online channels, designer stores, upscale gift shops, museums, and art galleries.

Further, some conventional systems are configured for associating consumer-provided assets with physical objects using NFC tags. Further, some conventional systems make use of gemstones with embedded near field communication chips for communication with NFC enabled devices. Further, some conventional systems may use NFC tags with proximity detection. Further, some conventional systems are configured for cloud-based NFC content sharing. Further, some conventional systems may use film for printed hydrographic and methods of making and using the same. Further, some conventional systems use transfer printing apparatus. Further, some conventional systems use a printer for printing a film that can be hydrographically printed onto an object and a method of printing. Further, some conventional systems are based on a method for liquid surface activation of transfer film, hydrographic method, and hydrographic device implementing the same.

Further, serial production of Stonemaps will include production runs and limited series runs of Stonemaps of predetermined cities, places, and locations. Initial technical considerations will support serial production, with a recognition that further development will support the production of custom Stonemaps of any location on an on-demand basis.

The production of Stonemaps relies on the printing of high-resolution maps or images on special transfer media using a standard inkjet printer. This can be done in-house. For large volume film production, a specialized third-party film printing facility may also be considered. Shelf life and dry storage is a factor for the transfer media, both before and after printing.

Licensing terms for use of maps and map data for use in print may preclude the use of Google or Mapbox maps for this application. This is likely true of other commercial map data providers as well. The proposed solution is the use of OpenStreetMap, with the development and application of our map styles on OSM map data.

Print Production. The primary requirement for print production using OSM data is the adaptation of existing workflows (or the development of a proprietary application) to allow an in-house designer or technical user to work directly with OSM map data to experiment with and define a series of map styles that can be printed and subsequently used freely to produce Stonemaps.

The styled OSM maps must be optimized for a high-resolution output between 150-300 dpi. Ideally, the output files can be vector-based or otherwise high-resolution raster-based files. For testing purposes, these will be output on a small (letter size) or mid format (13×19) inkjet printer for review, comparison, and validation. For future serial production, output files may be assembled in a grid pattern with an N-up page layout arrangement as required.

Mapbox, SnazzyMaps, Mapnik, Open Map Styles, may be examples of map styling workflow/UI. A number of excellent OSM styling applications also exist. See Mapiful as an example of a custom style applied to OSM data for print-ready commercial purposes. See Stamen maps as further examples of styled OSM maps.

Key considerations are:
The creation of a cost-effective implementation and/or adaptation of existing workflows (or ad hoc application) that will allow a skilled user to play and experiment with various map styles using OSM data, and print output locally as required for testing and validation, define and apply a series of map styles using OSM data to produce maps for ongoing serial production purposes, and assemble output files in a grid pattern with an N-up page layout arrangement as required, for eventual large format printing.

Further, the stonemap may be associated with custom Stonemap UX-UI and Production. In addition to the serial production runs, the Stonemaps platform will also support user creation of bespoke Stonemaps. These localized maps can be composed on the platform by individual users and then ordered for production. The platform will support further customization by participants in some ways. These will be developed in a series of phases:
1. Custom Stonemaps. This option will provide users the ability to choose a specific location and zoom level for their Stonemaps, and allow them to select a visual map treatment from a gallery of map styles (which can grow over time).
2. Style Customization. In a subsequent phase, the platform could also support dynamic map styling, allowing users to define their map styles. These could also be added to the gallery of available map styles for other users.
3. Personalized Stonemaps. The platform may provide support for users to upload their images to the platform. Support for personalized Stonemaps would require several additional considerations, and is currently outside the scope of this document.

Two key processes are required in the creation of Custom Stonemaps, namely, Map selection and Print production.

Further, map Selection and Customization takes place on the Stonemaps platform accessed through a web browser. The Custom Stonemap UI will support non-technical users in manipulating previously styled maps to compose and create a facsimile of their intended Stonemap and then submitting that for the production of their Custom Stonemap.

While the use of styled OSM data may provide a workable path for producing the printable maps, it may not be the most cost-effective or scalable solution for rendering and serving up the tilesets for the platform, which may need to serve a large number of simultaneous requests from anywhere on demand.

A possible solution envisioned for the Map Selection and Customization UX/UI is the use of Google™ Maps or Mapbox service to provide the map data - in conjunction with the use of their APIs to build a custom UI overlay to support the project's requirements and the display of custom map styles.

While the use of these services may resolve potential issues with serving up map data online, it is important to note that any map styles used in the gallery must correspond precisely to the high-resolution maps used for print production. Ideally, they would be the same maps.

Key considerations are:
A UI that supports a gracious user experience in:
   Selecting and composing their desired map area
   Easily selecting and applying different styles from a map style gallery
   Offering the user a clear high-fidelity facsimile of the finished Stonemap
   Supporting user confidence in an informed choice, before submitting their order.
While the use of styled OSM map data for print allows for printing, it may create additional challenges in serving the data effectively on the web.
A technical implementation that can support multiple simultaneous requests of tilesets and is also scalable, efficient, and has low latency, ideally from a distributed network.

Further, the print Production may take place remotely at a production facility. A user's custom Stonemap order on the platform will generate a print-ready production file at the production facility that correlates precisely to the map composed online. This high-resolution image file will be queued for printing onto transfer media for the final production of each user's specific Stonemap.

Print production will require the use of vector-based or high-resolution raster-based files. Further consideration will be a foolproof correlation of the finished Stonemap to its originating order. Any printed information on the output file (eg: a correlating order number) which is outside the central transfer area will be lost in the transfer process.

Key considerations are:
The automated generation of a print-ready production file at the production facility, once a user submits their order online.
A direct 1 to 1 visual correlation between the screen resolution maps used on the platform and the high-resolution maps printed at the production facility.
Given a relatively limited window for the storage and use of custom printed media, the print output can be considered a print-on-demand service.
The maintenance of a foolproof correlation of the user's original custom map throughout the production workflow and final shipping/delivery of the stonemap.

Further, some conventional systems allow the user to create and print maps of anywhere in the world, in an infinite number of styles. Further, some conventional systems allow the user to create poster or shop pre-made maps. Further, the pre-made maps are available as posters and peel & stick murals!

Further, some conventional systems make it super easy to design and order a unique printed map of any piece of your world.

Further, some conventional systems allow the user to create own printable city map from OpenStreetMap data. Further, some conventional systems allow the user to create an interactive map with leaflet and OpenStreetMap. Further, some conventional systems are configured for creating printable maps

Further, the disclosed system may be associated with a framework to promote the formation of slow intentional networks with characteristics of gifting, dialogue, and collaboration. These networks are formed through the physical gifting of river stones that are hydrographically printed with maps and embedded with an NFC chip. When handed from one person to the next as a gift, a stone (through the scan of its NFC tag) opens a channel to its virtual network and asks the recipient to contribute to the intention of the network. This contribution can be of any type (voice, picture, text) and once gifted, becomes part of the collective knowledge of the network. The recipient is then tasked with gifting the stone to another. By introducing a physical stone as the mechanism for connection, this framework deliberately slows the traditional notion of social media networks and enforces a more considered personal, intentional interaction between the network constituents and their contributions. The intent is to blend the best of physical and virtual interactions towards deeper, more meaningful conversations that can collaboratively create, solve, and investigate—a kind of documented collective sentience, a network that can be deeply and reliably interrogated.

Further, the Stonemaps journey may begin with “what if?” What if we could create an intentional network through the act of gifting a beautiful object like a patterned stone? What motivations would prompt such an act of gifting? What would be the traces of that relational act and how would they accumulate to create value and strengthen existing bonds?

This interrogation originated from a feeling of being awash in information and yet shallow in conversation. The mediated virtual social network—the capacity to link to almost anyone—is not (yet) structured for good conversation, for the distillation of knowledge, for the promotion of a kind of collective sentience. For us, there is a sense that this is missing, that we used to have more depth in conversation than we do now. Perhaps it was not as connected, but it was deeper and less noisy. This decrease of order leads to more unpredictability which is, in effect, less intelligence. Proponents of the “quantified self” claim that offloading the creation of order to networks of algorithms will fill this gap. [1] That is, as long as we continue making data, eventually we will understand ourselves. Indeed, Harari warns of the inflection point when algorithms will know us better than we know ourselves. [2] While we grant that algorithmically-guided decision making will continue to form part of a more ordered future, we also believe that collective wisdom requires the more direct influence of first-hand experience, which is not easily translated to an algorithm but is readily conveyed to others through conversation. A good conversation diverges and converges around a shared state. It creates trust and intimacy. It takes time, practice, and patience. Unfortunately, the structure of current social networks is not designed for these kinds of conversation.

Social networks are, rather, optimizing for a quantity of content and time spent on a platform. This phenomenon has been articulated in depth by writers and thinkers such as Carr, Alter, Harris, Turkle, and others. [3, 4, 5, 6] What has become apparent is a descent into shallow, provocative, and often uncivil interactions. Solutions proposed by the major platforms for the restoration of civility online have mostly focused on small changes such as hiding the number of likes on posts or developing smarter algorithms that detect conduct that is against a platform's terms of service. [7] While there seems to be a recognition of the problem and its sources, the big platforms are hampered by a business model that is not aligned with the goal of good conversation. [8] Indeed, the “move fast and break things” mantra of Silicon Valley does not apply to itself. There are parallel conversations that argue for the slowing of media for a healthier relationship to our digital ecosystems. [9, 10, 11, 12] They propose a redesign that takes as inspiration the Slow Food movement and asks us to mind the means of production and consumption. A related concept is that of The Commons articulated by the P2P Foundation, [13] which advocates for the participatory creation and stewardship of common goods that are universally accessible (“Productive citizens in communities creating shared resources.” [14]) Taken together, these ways of structuring media aim to deepen engagement and produce a collective sustainable abundance of knowledge. Michel Bauwens of the P2P Foundation argues for “subversive constructionism” to build different kinds of social networks that provide what we need. Stonemaps is our contribution to the subversion of existing social media networks. It is a provocation based on slow intentional networks of gifting. The values that animate Stonemaps are in line with those of the Slow Media Manifesto and include: intimacy, trust, dynamism, curiosity, generosity, creativity, responsibility, joy, collaboration, preciousness, intentionality, and the gift. It may start with the humble stone as the material anchor for the Stonemaps network. A stone takes its time, measured in eons. Over millennia a stone comes into itself and gains its identity. Its beingness is timeless and expressed through its form and its materiality. It has been here for eons before us and will be here for eons after we are gone. It warms from the heat of our hands as we hold it and has a focused weighty presence—a kind of “thing-power” as described by Bennett. [15] The stone is also a metaphor of our own context—a reminder of the very large stone that we are all standing on and share, and upon which our existence is so thinly spread like a film or a pattern on a stone. Holding the stone is symbolic of stewardship for what is beneath our feet. In that way, the stone has a grounding force that moves through us and quiets our abstraction—at least momentarily. This may be the magic of stones and why humans like to pick them up and hold them—but then we throw them away—and in that, they are symbolic of our personal power as well. We have to decide what to do with them once we have them in hand: throw them away, throw them at someone, skip them on the water, abandon them—give them as a gift. The Stonemaps stones are smooth river rocks that are modified to contain an NFC tag. They are also visually embellished with a pattern printed on their surface—a map. Further, the stones travel as gifts, creating an intentional network as they change hands. Giving a stone to another person is a kind of entrusting of a shared intention, an invitation to join a Commons. The stones are travelers on the waves of gifting, on the generosity of human curiosity. The stone, once given, can be read by a mobile device that then reveals a glimpse of its travels and prompts a contribution to a virtual network. In this way, there are always two layers to each Stonemaps network: the physical material layer of the traveling stone and the virtual layer of the network of stone recipients that continue to contribute to the network's intention. The momentum of the stone is the energy of the network and regulates its speed. The intention of the network can take many forms. Perhaps the stone wants to arrive at a particular destination, meet a particular person, answer a complex question. Perhaps the intention is driven by an Artificial Intelligence which sets an alien agenda, puzzling to the network initially but eventually becoming clearer as a diverse set of human minds are prompted toward the intention. The intention of the Stonemaps network is satisfied through the input of the members of the network as the stone travels from hand to hand.

The Stonemaps mechanism of exchange and growth is quite simple and yet contains within it some powerful principles. The requirement of making a personal connection with another person and entrusting them with the stone as a gift slows down the growth of the network and underlines the responsibility of now holding the stone and its intention. This is aligned with point 2 of the Slow Media Manifesto:

Slow media promote Monotasking. Slow Media cannot be consumed casually, but provoke the full concentration of their users. As with the production of a good meal, which demands the full attention of all senses by the cook and his guests, Slow Media can only be consumed with pleasure in focused alertness. [9]

The gift encounter can engender a feeling of sensuous enchantment that Bennett defines as “that strange combination of delight and disturbance,” [16] which, she posits, can prompt a more ethical engagement with the everyday world. Indeed, she takes this idea further in a later publication by taking a critical look at the catalytic effects of non-human bodies in this relation of enchantment. [15] The artist Lee Mingwei has also investigated the feeling of delight and disturbance in his participatory installation Moving Garden where visitors are invited to take a flower with the obligation to gift it to a stranger that they encounter while taking a detour from their usual route home. [17] In this way, he introduces strangeness to both the gifter and giftee, inducing what may be a quite profound experience.

During the Stonemaps gifting encounter, there is a transfer of information about the network and its intention. The gifter communicates the obligation inherent to the gift to the intended recipient. Not only is this transaction slow but the contribution requested from the Stonemaps network also demands focused attention—it is not a throwaway tweet or picture but rather a significant first introduction to the network and a serious engagement with the network's intention. There is likely to be a significant delay between being gifted the stone and gifting it to the next person, as the new recipient considers their first contribution. All of these layers of slowness around the ritual of the gift stress the importance of nontrivial engagement.

The stone, however precious it may look and feel to the holder, cannot be kept as a possession. Its value is intricately tied to its movement as it catalyzes the growth of the network and the addition of new data to the network. The beauty of the stone is representative of the value of the gift, not as an object but as an invitation into a rich dynamic conversation. The role of the gift in its various forms within human societies has been well studied and eloquently articulated by Mauss and Hyde. [18, 19, 20] Some gifts are ritualized and form part of a cyclical exchange (e.g. the Kula rings of the Trobriand Islands), or serve as symbolic proofs of tribal ties on a macro scale (e.g. ostrich eggshell beads of the African Kalahari Desert), [21] or are a demonstration of communal shared wealth (e.g. Northwest Potlatch). In all cases, gifts carry with them social obligations that strengthen communal bonds. By operating outside of the commodity market, they promote inter-dependency over individualistic freedom. The act of gifting enacted in the Stonemaps network encompasses three obligations:

The Obligation to Give: There are two layers of gifts acting within the Stonemaps network: the gift of movement of the stone to the next recipient (the stone wants to travel), and the gift towards the Stonemaps network intention (the network seeks). The network needs to motivate the current holder of the stone to both to contribute towards the intention of the network and to gift the stone to another. This can be achieved through personal persuasion from the previous gifter (see The Obligation to Reciprocate) or through network benefits that only accrue once the stone is gifted. If the holder fails to uphold the obligation to give, the stone will continue prompting the holder to “set it free”

The Obligation to Receive: The acceptance of the stone is both a commitment and a burden. By accepting the stone the recipient implicitly promises to fulfill the contract to reciprocate, to become part of a communal bond. The stone asks for a thoughtful contribution to the network's intention and an eventual departure toward its next recipient. The intended recipient is free to refuse the gift; however, a trace of that refusal remains as a kind of recorded interpersonal loss.

The Obligation to Reciprocate: The obligation to reciprocate is an onus and privilege—a worthy imperative. The gifter imparts the importance of the obligation to the recipient of the gift and hopes that this social tie will be sufficient for the stone to remain in motion. Traditionally, the failure to reciprocate is seen as a “debt bond” that does not expire. [19]

If these obligations are fulfilled, the full richness of the gift becomes apparent: a dynamic and intimate group of actors committed to contributing to a varied and deep conversation for the benefit of the network.

“It is the cardinal difference between gift and commodity exchange that a gift establishes a feeling-bond between two people, while the sale of a commodity leaves no necessary connection. [. . . ] a gift makes a connection.”—Lewis Hyde, The Gift. p. 72 [18]

Successive connections between people, bonded through gift exchange, are aggregated in the stone's memory. By acquiring contributions from participants over time, the stone accumulates greater worth and symbolic value. This cumulative accretion transforms the humble stone into a talisman—a fusion of person and thing. In turn, the talisman amplifies and affects subsequent personal connections, enriching the network over time.

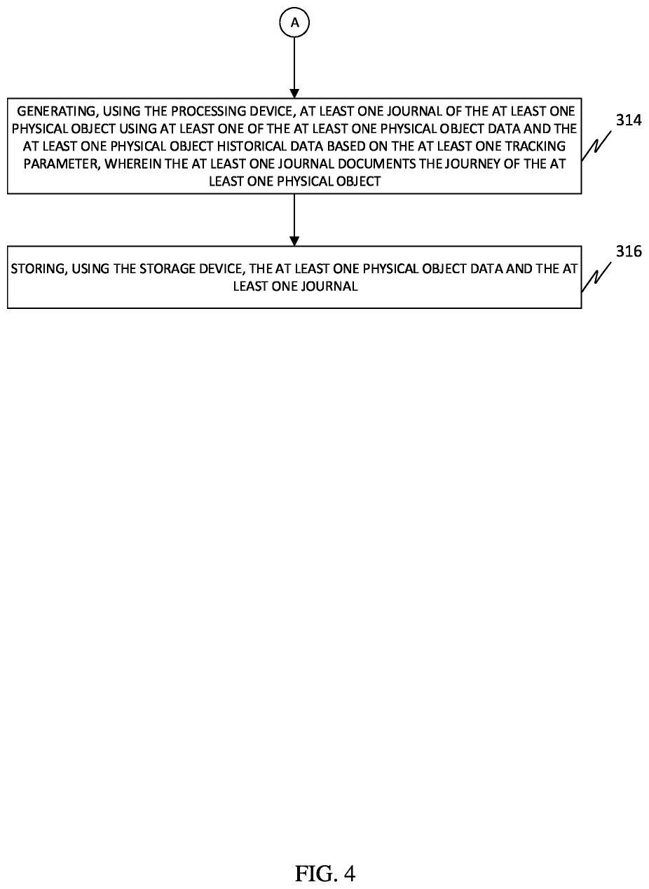

The stone travels on paths of “weak ties”—connections between diverse groups of strongly interconnected individuals (strong bonds). Weak ties typically represent inter group connections made by individuals, across networks (See FIG. 4). For example, a person may know very well the person they are gifting the stone to and may have chosen them specifically for the network but (especially over time) the existing members of the stone's network are likely to have a much more distant connection to a new member. The stones travel along these lines of connection thus acting as bridging devices and encouraging diversity, a wider world view, empathy, novelty, and innovation. Granovetter was the first to show the importance of weak but bridging ties between networks. [22] He showed that strong bonds tend to favor dense clustered networks and that, in the absence of weak bridging ties, information flow was segregated and less novel. Later, the concept of the “bandwidth” of a connection was added by Aral and Van Alstyne [23] to foreground instances where strong bonds do correlate well with novel information simply by virtue of greater frequency of exchange even if the overall proportion of novelty was lower than that of weak ties. From the point of view of the Stonemaps network model, we are looking to maximize reach and diversity while strengthening the overall bandwidth of the network. So, while the initial ties to the Stonemaps network may be weak, they are strengthened over time through a common intention and motivation. The obligation of the gift provides the initial momentum towards stronger ties, which then evolve as the benefits of the network accrue to the group (The Commons).

Once the gift of the stone has been received and reciprocated, the former holder of the stone is now a full-fledged participant in the virtual Stonemaps network. This network functions in many of the same ways as the social media networks we are accustomed to (e.g. accounts, contributions, and comments), however, its function is based on the principles of The Commons. The members of the network are the creators and stewards of the contents of the network. The network is governed by its members and its value accrues to them (This is in stark contrast to the large social media networks currently in operation, which accumulate behavioral data from their members for the benefit of third-party clients (the prediction futures market) [8]). The activity and regulation of the Stonemaps network are communally decided and managed. There are many examples of successful physical and virtual Commons such as car sharing co-operatives, the Open Source Software movement, and Wikimedia. Elinor Ostrom, awarded the Nobel Prize in economics in 2009, conducted a worldwide study of common pool resource (CPR) groups. She found that groups are capable of functioning sustainably without requiring top-down regulation if they follow eight core design principles [24]:
1. Clearly defined boundaries;
2. Proportional equivalence between benefits and costs;
3. Collective choice arrangements;
4. Monitoring;
5. Graduated sanctions;
6. Fast and fair conflict resolution;
7. Local autonomy; and
8. Appropriate relations with other tiers of rule-making authority (polycentric governance)

It is beyond the scope of this paper to fully describe these design principles but even in their short form, they allude to some of the pitfalls that are being averted. The Stonemaps network will be implemented in a way that supports these design principles both technologically and inter-personally. One common pitfall of social media networks is the presence of bad actors—conflict instigators and trolls. One of the ways in which the Stonemaps network mitigates this pitfall is through the mechanism of the physical gift to grow the virtual network. Every person in the network will have been seen and spoken with by at least one other member of the network. Indeed, the inherent obligation of the gift will preclude many potential bad actors. Beyond this, there will be other mechanisms within the network that select for collaborative actions towards shared goals, and give the group the ability to isolate problematic individuals.

While the movement of the stone through gifting gives form to the network, the intention of the network is the mechanism by which it creates the value that is shared by its constituents. The intention of the network influences how stone recipients are prompted to contribute to the network, and how these contributions are further distilled into knowledge, solutions, creations. Through the framework of The Commons, Stonemaps networks become support for thinking and creating together—a collective sentience.

This section presents some possible scenarios of intentional Stonemaps networks. A network is seeded by the purchase of a stone with a chosen visual imprint. The purchaser can be the one to set the Stonemaps' first intention or can leave it to system chance. In either case, the purchaser must gift the stone to another, thereby starting the Stonemaps chain of events.

In every scenario, when a new recipient accepts the stone, they scan it using their phone and the network passively logs information about the location of the stone (GPS coordinates or what3words). This is the location of the gift exchange and the set of all exchange locations will form one basis for network visualization.

Scenario 1 with its intention as a destination includes the following. I want to get somewhere! In this scenario, the stone has an intent to travel to a particular geographical location or perhaps to be handed to a particular person. This intent may or may not be explicitly stated and known to the members of the network. In the case where the intent is not explicitly stated, the stone reveals glimpses of its intent through nudges towards its destination (“I want to travel far West of here but still within this country” or “I'm looking for a singer from a punk band”). The current holder of the stone has the responsibility of finding someone who can propel the stone towards its destination and convince this person of the importance of this mission. As the stone travels from hand to hand, the network is charged with documenting its travels and adventures. It will ask for a contribution from the new recipient in a form that is dependent on the network's intention and the way the stone's travels are to be documented. Perhaps the documentation is a picture of the location of the exchange along with a short story of why there is hope it will lead to the stone's desired destination. Perhaps it is strictly a soundscape of the exchange location. Once the contribution is accepted by the network, the stone gives its next prompt and moves along. The existing members of the network have full access to the documentation of the stone's travels and can choose to remix and synthesize the contributions and give advice toward the next contribution or gift recipient.

Scenario 2 with its intention as a question includes the following. I want to know something! In this scenario, the stone seeks an answer to a question. The question can be initiated by the purchaser of the stone, or by the network. Each new recipient is briefed on the question by the stone gifter and can see the last answer given. They can choose to enhance or counter the previous answer or give a completely new answer. In all cases, they are charged to take as much time as they need. Constraints on the length of the answer or the format of the answer may be attached to the request. Once the contribution is submitted and approved by the network, the stone prompts the current holder of the stone to find another person who could contribute a valuable point of view on the question at hand. As the stone collects answers to the question, the existing network constituents can deepen the inquiry by conversing on the different contributions, perhaps adding relevant references, and synthesizing a multi-faceted and nuanced document. The network is ultimately responsible for “calling” the question—deeming the inquiry finished and setting a new intention for the stone.

Scenario 3 with its intention as co-creation includes the following. Let's make something! In this scenario, the stone is asking for contributions to a collaborative making project. This can be an artwork such as a collage or film, a poem, or a narrative. It can also be a collaborative design document for a new park, say. Each new recipient of the stone is asked to contribute to a particular aspect of the collaborative creation or to give towards a “wildcard” direction. They may not have a full view of the creation so far until they are a full-fledged member of the network. As with all previously described scenarios, the contribution is first vetted by the network before prompting the current recipient to give the stone to another. Once the stone is gifted onward, the co-creation is visible to the new member. In this scenario, as with the Question scenario, the network members have a responsibility for managing the assets collected by the stone's travels. The contributions can manually be composited towards a finished product, or be input into a generative artwork that continues to grow as the stone travels.

Scenario 4 with its intention as a quest includes the following. Let's find the gold! In this scenario, the stone prompts the network towards the ludic discovery of a virtual game world. The stone's intent may be set by game mechanics that involve specific geographic locations, similar to geocaching. When the stone reaches specific locations, more of the game map is revealed or assets are collected (health points, tools, etc.) and the network constituents can make a decision about where the next step they would like to take in the game. This slow game is a combination of the physical movement of the stone and goalsetting by the virtual network.

These scenarios can also be combined as sub-intentions to a greater intention. For example, if the network wants to start by talking to a sociologist before setting a question, it can set a sub-goal of finding a sociologist and, once found, ask them for an opinion on what aspects the question should target. In this way, the Stonemaps network interface supports both exploration (going deeper with sub-inquiries) and synthesis (resolving pending inquiries). If two stones cross paths, they have the option of becoming an entangled pair. The exchange is a mutual gift and the networks can choose to merge and share future intentions or to work collaboratively with distinct goals. Or they can choose to merely greet each other, mark the encounter, and continue as before. If they choose to become entangled, the networks continue growing on separate paths but share all information. After an intention is satisfied or deemed inconclusive, the next intention is agreed upon by the network and the stone's adventure continues. Over time the network builds a kind of expertise, a way of manipulating the stone's movement to create value for the Commons. It attains collective sentience that can be depended upon.

The purpose of describing the Stonemaps project in this context is to enter into the discourse about new models of social engagement that emphasize values of shared generated wisdom—what we have called collective sentience. The tension between individualism/capitalism and The Commons is not new but with new technologies, we are seeing opportunities to insert ways of resisting the push towards the enclosure of knowledge and the design of interfaces that promote shallow engagement and invisible manipulation. We are not claiming that Stonemaps networks will be the best or even a successful framework for a new model of engagement. However, it is a mindful collaborative development of what we hope will be an enchanting new way of being in blended physical and virtual networks, one that will inform future efforts in this area and attract like-minded individuals.

The stones of the Stonemaps network have been constructed and tested with various phones. The first visual designs for the stones are maps, both real and fictional, to indicate the stone's impulse towards movement. Future designs may include more abstract representation, maybe tied to a particular network's intended expertise such as a gaming stone.

The implementation of the application layer that supports the intentional network is in development. Because we want to create an environment that operates outside of the surveillance capitalism frame, we are looking to software tools that not only safeguard user privacy but are in line with the common ideals of putting the users in control of any data accumulated on the platform. The Stonemaps network can only be successful if the constituents know they control the interface with others outside the network—they cannot feel they are being watched or manipulated in any way. We are currently looking at an Open Source solution from Oasis Labs that is designed to support private and secure decentralized applications, using blockchain technologies for data integrity. [25] Other open source third-party tools such as those developed by Inrupt (a company founded by Sir Tim Berners-Lee) are also being investigated as a way to store and control access to personal information.

The application will be multi-platform and support social media functions such as user accounts and profiles, and mechanisms for adding content to the network (posts, conversations), synthesizing new content from existing content (cocreation), archiving, and management of resources. We will develop the application in stages and test different scenarios to inform the next steps and requirements. One important aspect of the User Interface is that it supports the gifting process without the excessive technological or cognitive overhead. There should be some immediate visibility of the Stonemaps network aggregate identity and intention without any barriers beyond scanning the stone's NFC tag

After a member's initial encounter with the application, the design should support the principles of The Commons by providing tools and interfaces for: conversations and consensus building; content creation; management and distribution of resources towards a sustainable network; documentation and archiving; management of network intention and membership; and conflict resolution.

At the core of the implementation and the user interface are the values of the Stonemaps network, first outlined in the introduction: intimacy, trust, dynamism, curiosity, generosity, creativity, responsibility, joy, collaboration, preciousness, intentionality, and the gift.

Further, for the first stage of testing, we are designing a barebones application to collect data on some example scenarios such as the ones outlined above. We will release 5 sets of 5 stones, each set being assigned a scenario with slightly different parameters of engagement. This phase will also include a short survey suggested to the participant once they open an account with the network, and periodically throughout the testing period. They can refuse to fill out the survey without any effect on their ability to continue in the Stonemaps network. We will monitor the stone's movements for a set period of time to study the effectiveness of the different scenarios on the stone's momentum. This monitoring will be strictly limited to the stone's range and frequency of movements. Any additional monitoring and feedback will be voluntarily contributed by the network constituents.

There are two aspects of sustainability that are pertinent to the Stonemaps network: its ability to keep the stone in movement and the members engaged in conversation; and its ability to generate revenue to support the maintenance of the platform and the network's greater goals if these require resources. We have discussed some motivational elements to keep the stone in motion in previous sections and we expect to further refine these as we receive the results of the first test scenarios. Some of the motivation will come from the way in which the constituents of the network arrange themselves but successful strategies will also have to be supported by an apt interface. Financial sustainability is likely to be achieved through many different means. Initial project development funding is envisioned through project development grants, investment, and crowdfunding. Seed revenues originate from the direct sale of stones. Subscription models would further sustain the basic operation of the platform, and stone networks would be able to attract donations from its growing membership. Other revenue sources could come from the provision of services especially as the networks gain some proficiency and documented knowledge. For example, a network could be valued for its diversity across different demographics, and could make a point of maintaining this as a basic component of all its intentions. This diversity, in turn, could make it valuable to those who need information from a diverse group. In this situation, the network could offer a polling service or a set of user-derived prediction data. In a more general case, the expertise of a network can be advertised and instrumentalized to generate revenue. The selling of users' demographic, geo-location, and behavioral data has been amply proven as a lucrative business model. Typically, this value generation has bypassed the data generators themselves. We are interested in exploring ways to evolve this practice, to preserve the sovereignty of user data, provide transparency and consent regarding data usage, and reward users directly and commensurately through the support of network projects and initiatives.

If the network generates a surplus of revenue, the members can choose to direct the funds towards external projects that they find valuable or fund new projects spearheaded by its members. We envision Stonemaps acting as a philanthropic venture, supported by a variety of sources and enabled by distributed ledger functions.

Stonemaps are slow media. They traverse personal connections to create thoughtful, real-world networks built along invisible currents of affinity. Stonemaps is both a social experiment and a distributed art project—online social media that is deeply connected to the physical world through hand-to-hand connections. Stonemaps are emergent networks—creating new ripples of rich connection, shared experience, meaning, and value as the project unfolds. We have presented the foundational elements for the design of Stonemaps. Many of these elements, though based on careful research on gifting and social networks, are still at the speculative stage. An iterative design process will continue to respond to the emerging dynamics of the launched stones. Initial prototypes show the potential of delightful engagements reminiscent of the first hopeful dips into social media. It is our hope that Stonemaps and their intentions contribute to the design of a more democratic social media space.

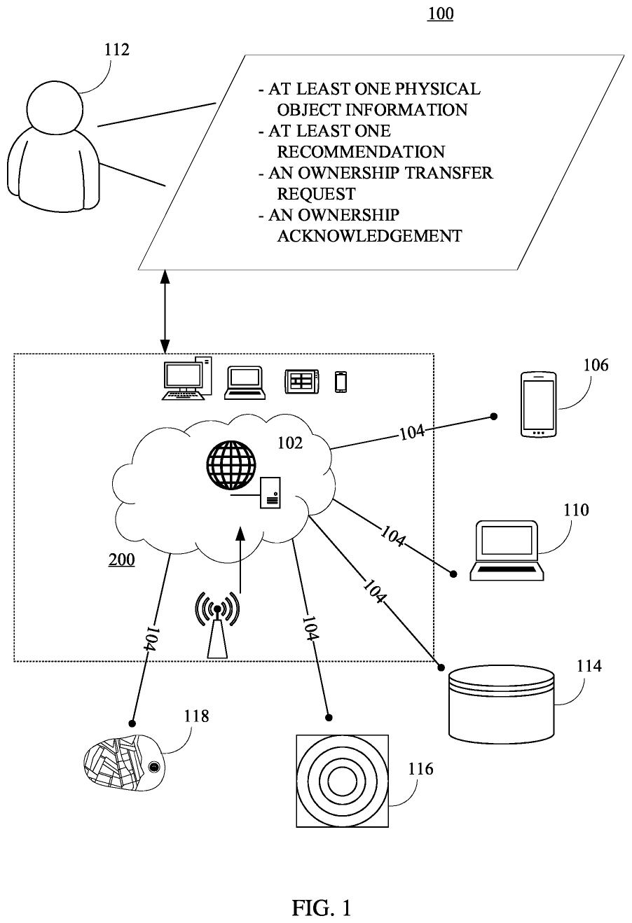

FIG. 1 is an illustration of an online platform 100 consistent with various embodiments of the present disclosure. By way of non-limiting example, the online platform 100 to enable facilitating documenting journeys of physical objects may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers etc.), databases 114, sensors 116, and a stonemap 118 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

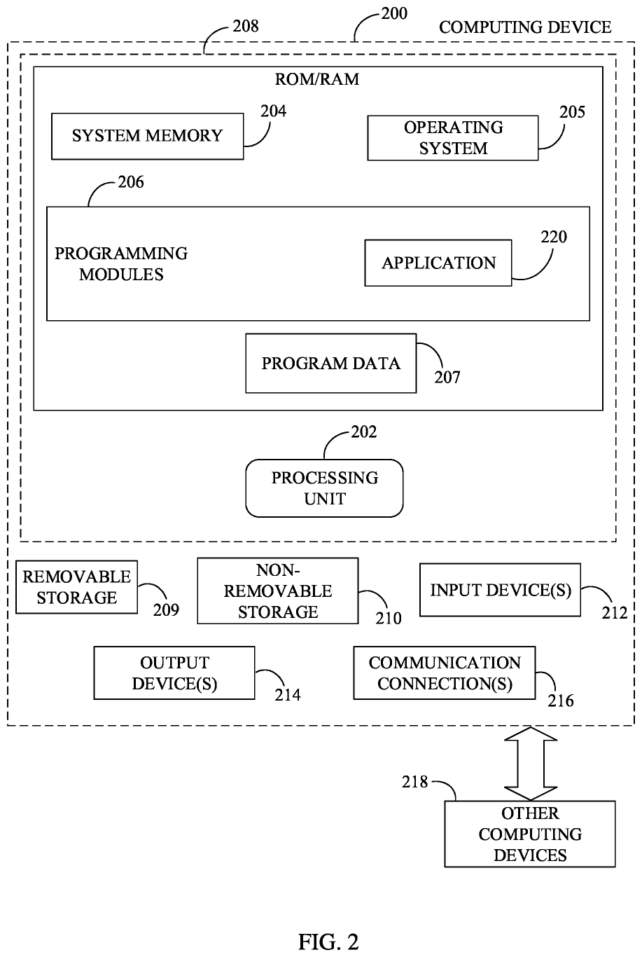

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

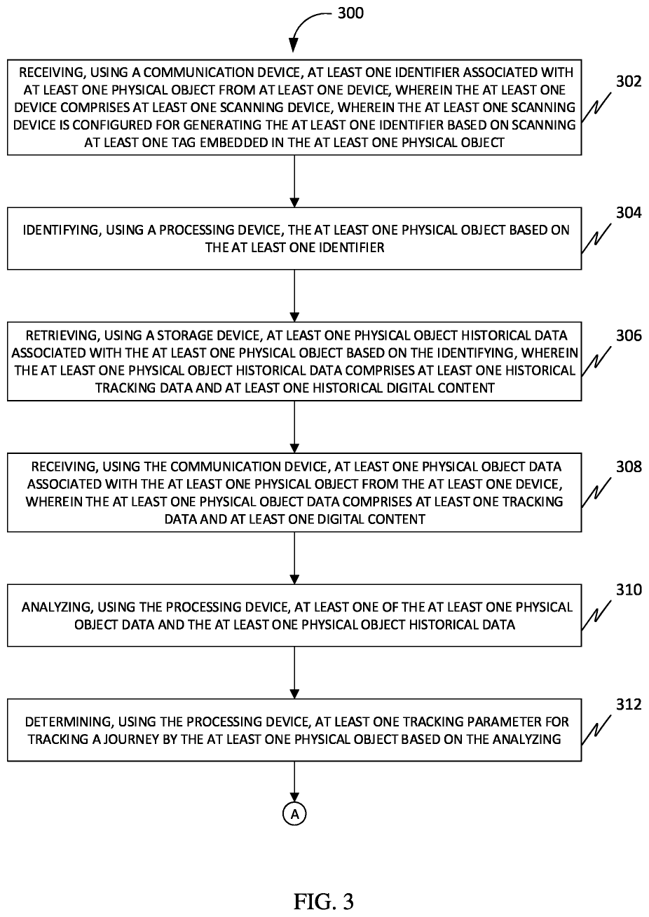

FIG. 3 is a flow chart of a method 300 for facilitating documenting journeys of physical objects, in accordance with some embodiments.

Further, the method 300 may include a step 302 of receiving, using a communication device (such as a communication device 1302), one or more identifier associated with one or more physical object from one or more device. Further, the one or more identifier may include a name, a number, an image, etc. Further, the one or more physical object may include a memorabilia, a souvenirs, a stone, a pebble, a rock, a boulder, etc. Further, the one or more device may include a computing device such as a laptop, a smartphone, a desktop, a smartwatch, etc. Further, the one or more device may include one or more scanning device. Further, the one or more scanning device may include a camera. Further, the one or more scanning device is configured for generating the one or more identifier based on scanning one or more tag embedded in the one or more physical object. Further, the one or more tag may include a RFID tag, a NFC tag, a Bluetooth tag, a physical tag, etc.

Further, the method 300 may include a step 304 of identifying, using a processing device (such as a processing device 1304), the one or more physical object based on the one or more identifier.

Further, the method 300 may include a step 306 of retrieving, using a storage device (such as a storage device 1306), one or more physical object historical data associated with the one or more physical object based on the identifying. Further, the one or more physical object historical data may include one or more historical tracking data and one or more historical digital content. Further, the one or more historical tracking data may include any data associated with a tracking of the one or more physical object. Further, the one or more historical digital content may include an audio content, a video content, a textual content, a graphical content, etc.

Further, the method 300 may include a step 308 of receiving, using the communication device, one or more physical object data associated with the one or more physical object from the one or more device. Further, the one or more physical object data may include one or more tracking data and one or more digital content. Further, the one or more tracking data may include any data associated with a tracking of the one or more physical object. Further, the one or more digital content may include an audio content, a video content, a textual content, a graphical content, etc.

Further, the method 300 may include a step 310 of analyzing, using the processing device, one or more of the one or more physical object data and the one or more physical object historical data.

Further, the method 300 may include a step 312 of determining, using the processing device, one or more tracking parameter for tracking a journey by the one or more physical object based on the analyzing. Further, the one or more tracking parameter may include a date, a location, a time, etc. Further, the location may include a geographical location such as a city, a county, a state, a country, etc.

FIG. 4 is a continuation flow chart of FIG. 3.

Further, the method 300 may include a step 314 of generating, using the processing device, one or more journal of the one or more physical object using one or more of the one or more physical object data and the one or more physical object historical data based on the one or more tracking parameter. Further, the one or more journal documents the journey of the one or more physical object.

Further, the method 300 may include a step 316 of storing, using the storage device, the one or more physical object data and the one or more journal.

In some embodiments, the one or more device may include one or more sensor. Further, the one or more sensor may be embedded in the one or more physical object. Further, the one or more sensor may be configured for generating one or more location data of the one or more physical object based on a location of the one or more physical object at a time. Further, the one or more tracking data may include the one or more location data. Further, the location may include a geographical location such as a city, a county, a state, a country, etc.

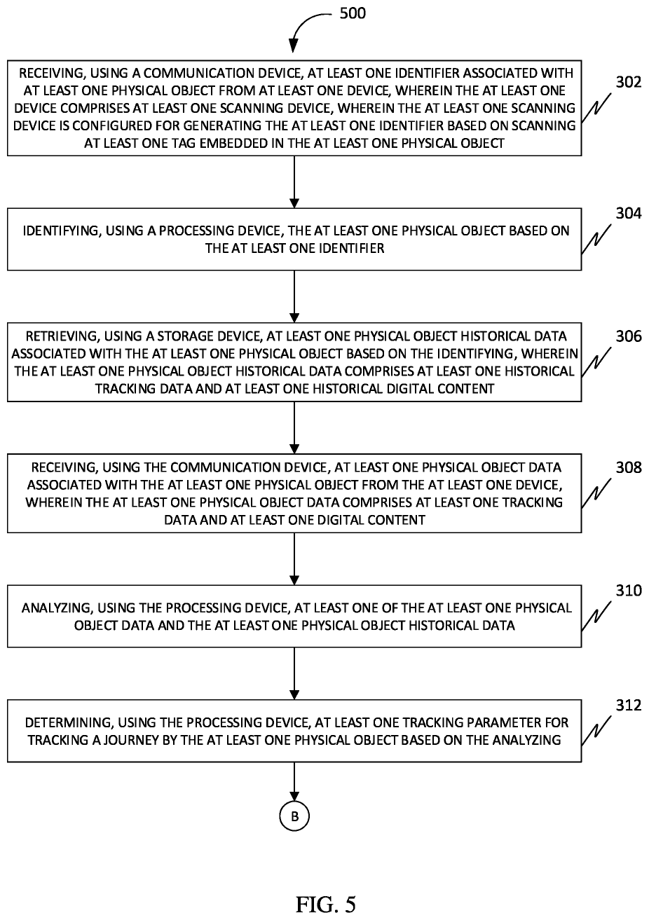

FIG. 5 is a flow chart of a method 500 for facilitating documenting journeys of physical objects in which the method 500 may include arranging one or more of the one or more digital content and the one or more historical content based on the one or more tracking parameter, in accordance with some embodiments.

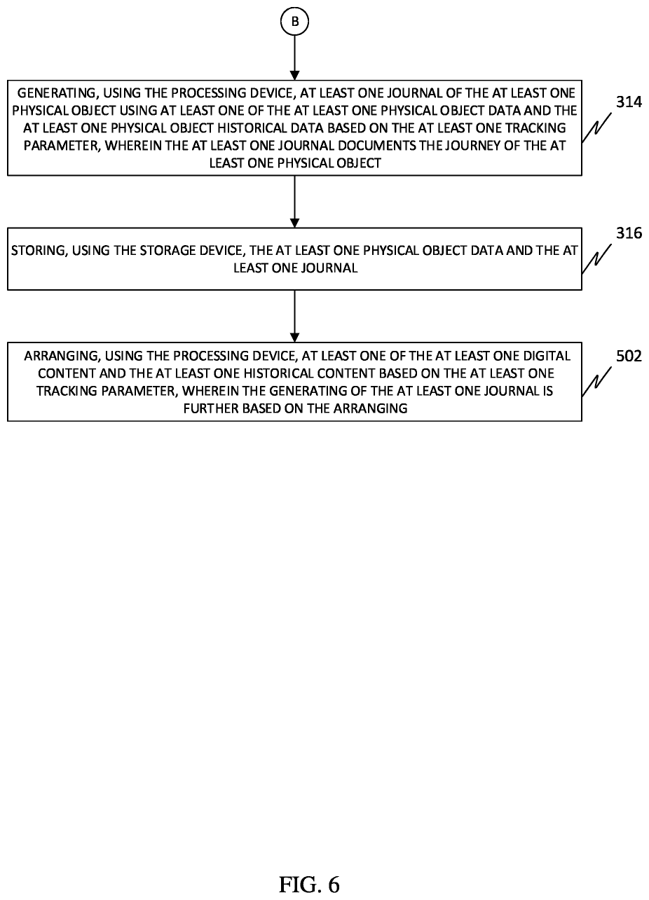

FIG. 6 is a continuation flow chart of FIG. 5. The method 500 includes steps 302-316 explained in detail in conjunction with FIG. 3 above. Further, at 502, the method 500 may include arranging, using the processing device, one or more of the one or more digital content and the one or more historical content based on the one or more tracking parameter. Further, the generating of the one or more journal is further based on the arranging. Further, the one or more digital content may be arranged in a chronological order based on the arranging.

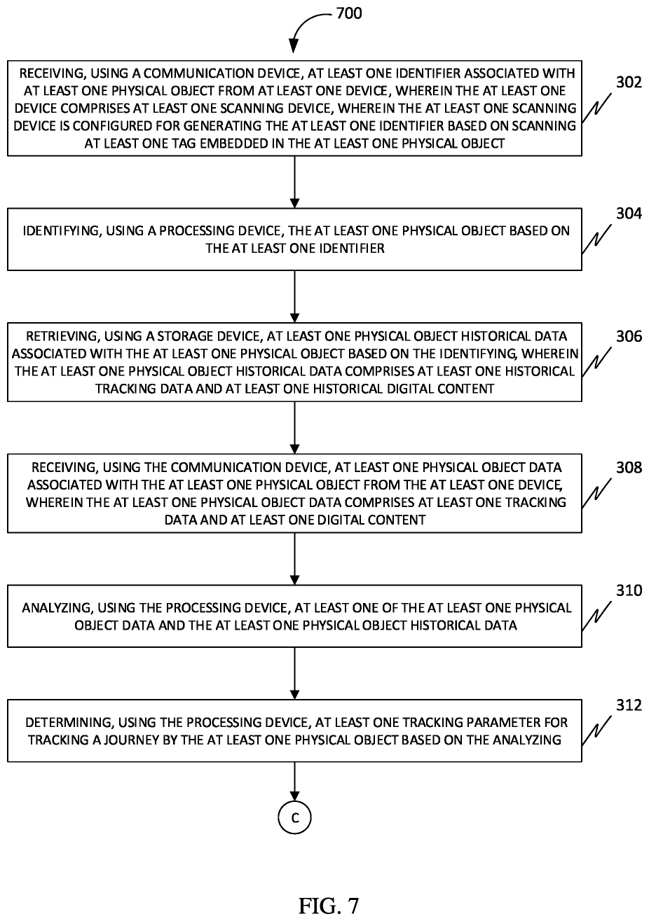

FIG. 7 is a flow chart of a method 700 for facilitating documenting journeys of physical objects in which the method 700 may include plotting one or more path traveled by the one or more physical object on one or more map based on the one or more location, in accordance with some embodiments. Further, the one or more tracking parameter may include one or more location of the one or more physical object. Further, the one or more path may be marked on the one or more map. Further, the one or more map may associated with at least one area. Further, the one or more map may include a world map, a country map, a state map, etc.

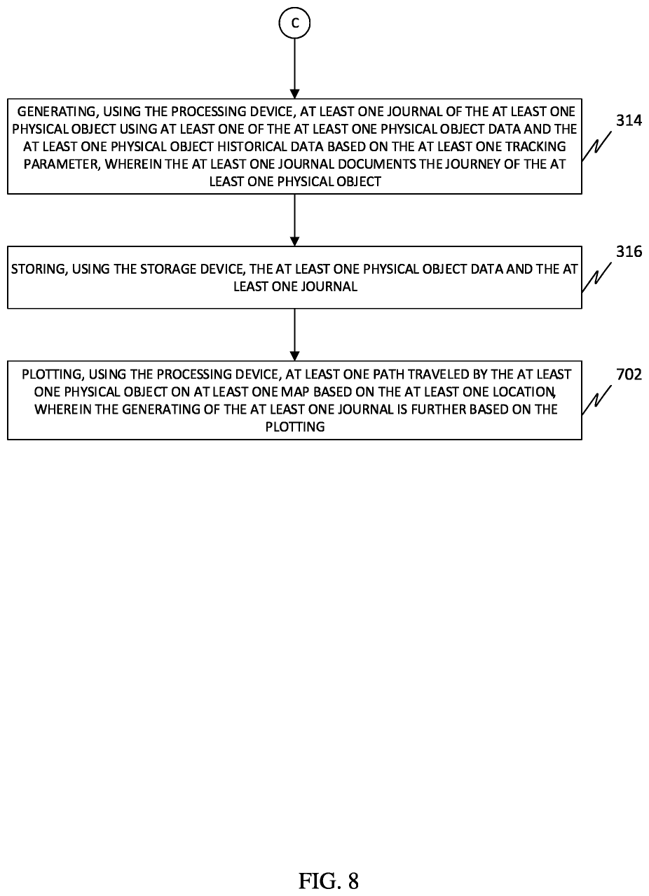

FIG. 8 is a continuation flow chart of FIG. 7. The method 700 includes steps 302-316 explained in detail in conjunction with FIG. 3 above. Further, the method 700 may include a step 702 of plotting, using the processing device, one or more path traveled by the one or more physical object on one or more map based on the one or more location. Further, the generating of the one or more journal is further based on the plotting.

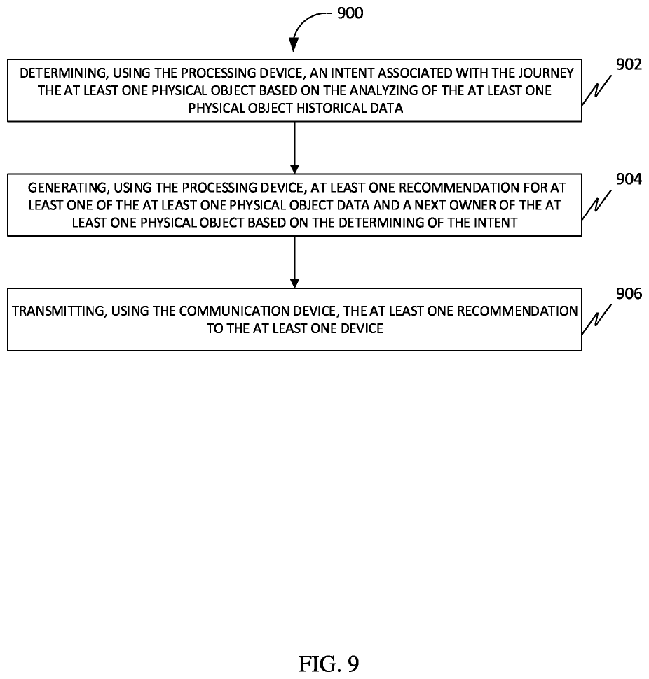

FIG. 9 is a flow chart of a method 900 for facilitating documenting journeys of physical objects in which the method 900 may include transmitting the one or more recommendation to the one or more device, in accordance with some embodiments. Further, the one or more physical object is owned by a current owner. Further, the method 900 may include a step 902 of determining, using the processing device, an intent associated with the journey the one or more physical object based on the analyzing of the one or more physical object historical data. Further, the intent may include an intent to travel to a particular geographical location, an intent to be handed to a particular person, etc. Further, the method 900 may include a step 904 of generating, using the processing device, one or more recommendation for one or more of the one or more physical object data and a next owner of the one or more physical object based on the determining of the intent. Further, the one or more recommendation may include a nudge, a suggestion, etc. for the intent. Further, the method 900 may include a step 906 of transmitting, using the communication device, the one or more recommendation to the one or more device.

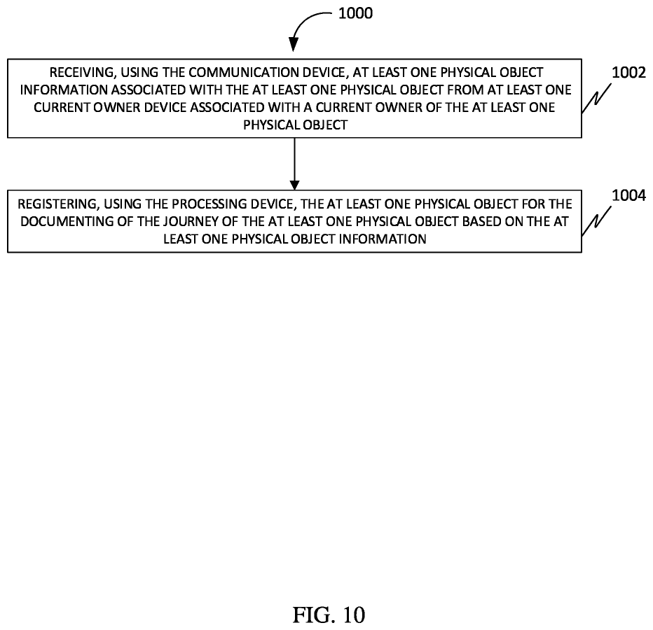

FIG. 10 is a flow chart of a method 1000 for facilitating documenting j ourneys of physical objects in which the method 1000 may include registering the one or more physical object for the documenting of the journey of the one or more physical object, in accordance with some embodiments. Further, the method 1000 may include a step 1002 of receiving, using the communication device, one or more physical object information associated with the one or more physical object from one or more current owner device associated with a current owner of the one or more physical object. Further, the one or more physical object information may include a name, a place of origin, a number, an ownership, a type, a size, a material, etc. Further, the current owner may include an individual. Further, the method 1000 may include a step 1004 of registering, using the processing device, the one or more physical object for the documenting of the journey of the one or more physical object based on the one or more physical object information.

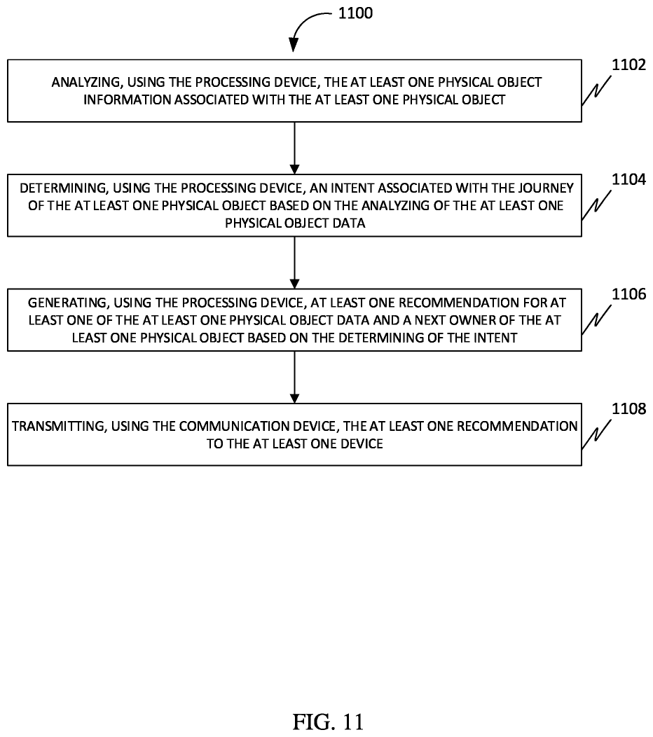

FIG. 11 is a flow chart of a method 1100 for facilitating documenting journeys of physical objects in which the method 1100 may include transmitting the one or more recommendation to the one or more device, in accordance with some embodiments. Further, the method 1100 may include a step 1102 of analyzing, using the processing device, the one or more physical object information associated with the one or more physical object. Further, the method 1100 may include a step 1104 of determining, using the processing device, an intent associated with the journey of the one or more physical object based on the analyzing of the one or more physical object data. Further, the method 1100 may include a step 1106 of generating, using the processing device, one or more recommendation for one or more of the one or more physical object data and a next owner of the one or more physical object based on the determining of the intent. Further, the next owner may include an individual. Further, the method 1100 may include a step 1108 of transmitting, using the communication device, the one or more recommendation to the one or more device.

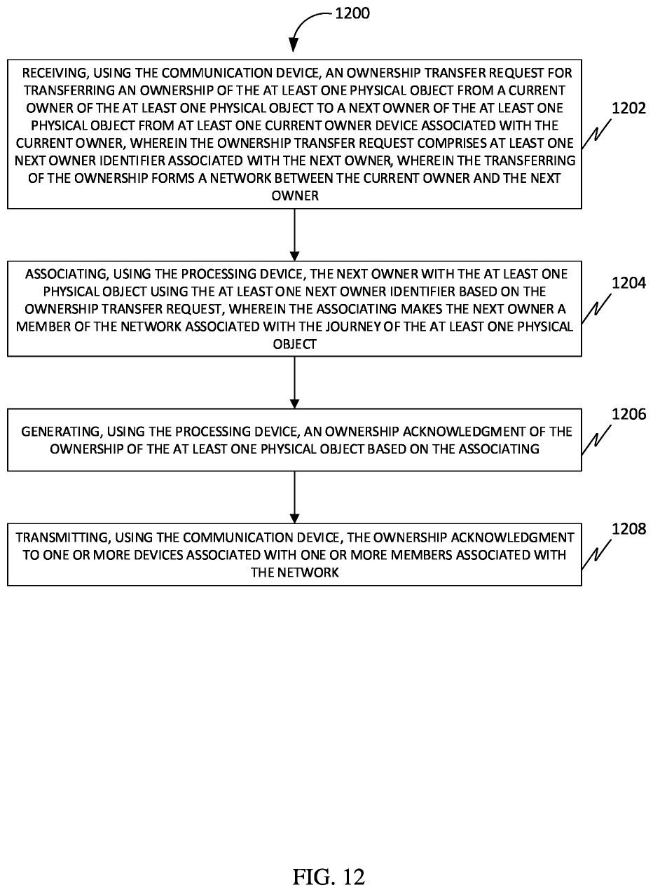

FIG. 12 is a flow chart of a method 1200 for facilitating documenting journeys of physical objects in which the method 1200 may include transmitting the ownership acknowledgment to one or more devices associated with one or more members associated with the network, in accordance with some embodiments. Further, the method 1200 may include a step 1202 of receiving, using the communication device, an ownership transfer request for transferring an ownership of the one or more physical object from a current owner of the one or more physical object to a next owner of the one or more physical object from one or more current owner device associated with the current owner. Further, the next owner may include an individual. Further, the current owner may include an individual. Further, the one or more current owner device may include a computing device such as a laptop, a smartphone, a desktop, a smartwatch, etc. Further, the ownership transfer request may include one or more next owner identifier associated with the next owner. Further, the one or more next owner identifier a name, a number, an image, etc of the next owner. Further, the transferring of the ownership forms a network between the current owner and the next owner. Further, the method 1200 may include a step 1204 of associating, using the processing device, the next owner with the one or more physical object using the one or more next owner identifier based on the ownership transfer request. Further, the associating makes the next owner a member of the network associated with the journey of the one or more physical object. Further, the method 1200 may include a step 1206 of generating, using the processing device, an ownership acknowledgment of the ownership of the one or more physical object based on the associating. Further, the method 1200 may include a step 1208 of transmitting, using the communication device, the ownership acknowledgment to one or more devices associated with one or more members associated with the network.

In some embodiments, the one or more device may include one or more capturing device. Further, the one or more capturing device may include a camera, a microphone, etc. Further, the one or more capturing device may be configured for capturing the one or more physical object data associated with the one or more physical object.

In some embodiments, the retrieving of the one or more physical object historical data may include retrieving the one or more physical object historical data from a distributed ledger. Further, the storing of the one or more physical object data and the one or more journal may include storing the one or more physical object data and the one or more journal in the distributed ledger.

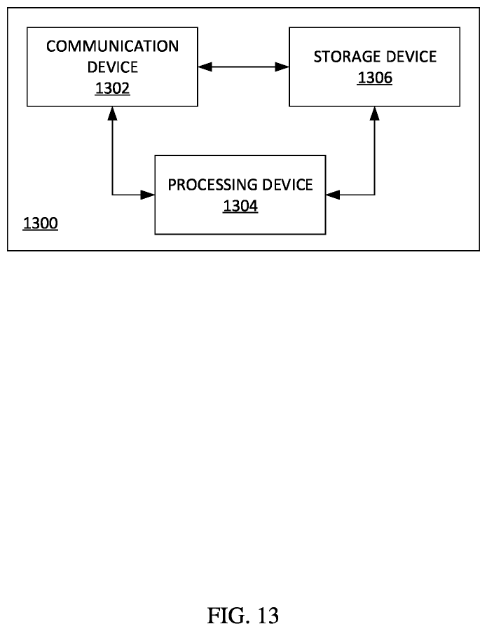

FIG. 13 is a block diagram of a system 1300 for facilitating documenting journeys of physical objects, in accordance with some embodiments. The system 1300 may include a communication device 1302, a processing device 1304, and a storage device 1306.

Further, the communication device 1302 may be configured for performing a step of receiving one or more identifier associated with one or more physical object from one or more device. Further, the one or more device may include one or more scanning device. Further, the one or more scanning device is configured for generating the one or more identifier based on scanning one or more tag embedded in the one or more physical object.

Further, the communication device 1302 may be configured for performing a step of receiving one or more physical object data associated with the one or more physical object from the one or more device. Further, the one or more physical object data may include one or more tracking data and one or more digital content.

The processing device 1304 may be communicatively coupled with the communication device 1302.

Further, the processing device 1304 may be configured for performing a step of identifying the one or more physical object based on the one or more identifier.

Further, the processing device 1304 may be configured for performing a step of analyzing one or more of the one or more physical object data and one or more physical object historical data.

Further, the processing device 1304 may be configured for performing a step of determining one or more tracking parameter for tracking a journey by the one or more physical object based on the analyzing.

Further, the processing device 1304 may be configured for performing a step of generating one or more journal of the one or more physical object using one or more of the one or more physical object data and the one or more physical object historical data based on the one or more tracking parameter. Further, the one or more journal documents the journey of the one or more physical object.

The storage device 1306 may be communicatively coupled with the processing device 1304.

Further, the storage device 1306 may be configured for performing a step of retrieving the one or more physical object historical data associated with the one or more physical object based on the identifying. Further, the one or more physical object historical data may include one or more historical tracking data and one or more historical digital content.

Further, the storage device 1306 may be configured for performing a step of storing the one or more physical object data and the one or more journal.

In some embodiments, the one or more device may include one or more sensor. Further, the one or more sensor may be embedded in the one or more physical object. Further, the one or more sensor may be configured for generating one or more location data of the one or more physical object based on a location of the one or more physical object at a time. Further, the one or more tracking data may include the one or more location data.

In some embodiments, the processing device 1304 may be configured arranging one or more of the one or more digital content and the one or more historical content based on the one or more tracking parameter. Further, the generating of the one or more journal may be further based on the arranging.

In some embodiments, the one or more tracking parameter may include one or more location of the one or more physical object. Further, the processing device 1304 may be configured for performing a step of plotting one or more path traveled by the one or more physical object on one or more map based on the one or more location. Further, the generating of the one or more journal may be based on the plotting.

In some embodiments, the one or more physical object may be owned by a current owner. Further, the processing device 1304 may be configured for performing a step of determining an intent associated with the journey the one or more physical object based on the analyzing of the one or more physical object historical data. Further, the processing device 1304 may be configured for performing a step of generating one or more recommendation for one or more of the one or more physical object data and a next owner of the one or more physical object based on the determining of the intent. Further, the communication device 1302 may be configured for performing a step of transmitting the one or more recommendation to the one or more device.

In some embodiments, the communication device 1302 may be configured for performing a step of receiving one or more physical object information associated with the one or more physical object from one or more current owner device associated with a current owner of the one or more physical object. Further, the processing device 1304 may be configured for performing a step of registering the one or more physical object for the documenting of the journey of the one or more physical object based on the one or more physical object information.

In some embodiments, the processing device 1304 may be configured for performing a step of analyzing the one or more physical object information associated with the one or more physical object. Further, the processing device 1304 may be configured for performing a step of determining an intent associated with the journey of the one or more physical object based on the analyzing of the one or more physical object data. Further, the processing device 1304 may be configured for performing a step of generating one or more recommendation for one or more of the one or more physical object data and a next owner of the one or more physical object based on the determining of the intent. Further, the communication device 1302 may be configured for performing a step of transmitting the one or more recommendation to the one or more device.

In some embodiments, the communication device 1302 may be configured for performing a step of receiving an ownership transfer request for transferring an ownership of the one or more physical object from a current owner of the one or more physical object to a next owner of the one or more physical object from one or more current owner device associated with the current owner. Further, the ownership transfer request may include one or more next owner identifier associated with the next owner. Further, the transferring of the ownership forms a network between the current owner and the next owner. Further, the communication device 1302 may be configured for performing a step of transmitting an ownership acknowledgment to one or more devices associated with one or more members associated with the network. Further, the processing device 1304 may be configured for performing a step of associating the next owner with the one or more physical object using the one or more next owner identifier based on the ownership transfer request. Further, the associating makes the next owner a member of the network associated with the journey of the one or more physical object. Further, the processing device 1304 may be configured for performing a step of generating the ownership acknowledgment of the ownership of the one or more physical object based on the associating.

In some embodiments, the one or more device may include one or more capturing device. Further, the one or more capturing device may be configured for capturing the one or more physical object data associated with the one or more physical object.

In some embodiments, the retrieving of the one or more physical object historical data may include retrieving the one or more physical object historical data from a distributed ledger. Further, the storing of the one or more physical object data and the one or more journal may include storing the one or more physical object data and the one or more journal in the distributed ledger.

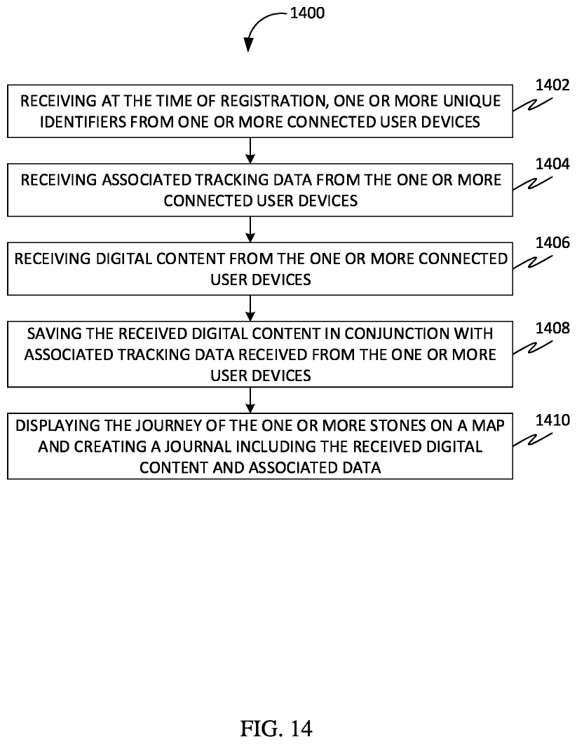

FIG. 14 is a flowchart of a method 1400 to facilitate the tracking of the location of a physical object to display a journey of the physical object on a map in the form of a journal, in accordance with some embodiments. Accordingly, the method 1400 may include a step 1402 of receiving at the time of registration, one or more unique identifiers from one or more connected user devices of a user, through a communication device. The one or more unique identifiers may include personal information such as the name, age, location, etc. of the user. Further, one or more unique identifiers may include additional information such as information associated with one or more stones of the user, such as the one or more serial numbers of the one or more stones and additional data retrieved from one or more tags embedded in the one or more stones such as RFID tags, NFC tags, and so on. In an instance, the one or more identifiers may be received through an input mechanism of the one or more user devices such as, for example, a desktop computer, laptop computer, a tablet computer, a mobile device, or a wearable device. Further, the one or more user devices may be configured to communicate with the communication device of a server computer. Accordingly, in an instance, the one or more identifiers input through the input mechanism may be transmitted from the one or more user devices to the server computer.

Further, the method 1400 may include a step 1404 of receiving, through the communication device, associated tracking data from the one or more connected user devices. The associated tracking data may include data such as the location of the user device and the time at which the associated tracking may be received. In an instance, the associated tracking data may be received through an input mechanism (e.g. a check-in button in a user interface) of the one or more user devices of the user such as, for example, a desktop computer, laptop computer, a tablet computer, a mobile device, or a wearable device. Further, the one or more user devices may be configured to communicate with the communication device of a server computer. Accordingly, in an instance, the associated tracking data input through the input mechanism may be transmitted from the one or more user devices to the server computer. In some embodiments, the associated tracking data may be automatically retrieved from the one or more user devices and/or transmitted to the server computer. The associated tracking data received from the one or more user devices may specify the location of one or more stones associated with the user profile of the user at a particular time, and therefore the location of the user at the particular time. Accordingly, the associated tracking data may indicate one or more locations that the user may have traveled to as a part of a journey. In an embodiment, the one or more stones associated with the user profile of the user may include one or more sensors, and devices, such as a location sensor e.g. a GPS, accelerometer, gyroscope, and so on. Accordingly, in an embodiment, the associated tracking data may be automatically retrieved from the one or more stones associated with the user profile of the user and/or transmitted to the server computer.

Further, the method 1400 may include a step 1406 of receiving, using the communication device, digital content from the one or more connected user devices. Digital content may include data such as such as one or more videos, pictures, text documents, etc. The digital content such as the one or more pictures, videos, and text documents such as blogs may have been captured by the user through one or more user devices and may be associated with one or more travels undertaken by the users. In an instance, the digital content may be received through an input mechanism (e.g. an upload button in a user interface) of the one or more user devices of the user such as, for example, a desktop computer, laptop computer, a tablet computer, a mobile device, or a wearable device. Further, the one or more user devices may be configured to communicate with the communication device of a server computer. Accordingly, in an instance, the digital content input through the input mechanism may be transmitted from the one or more user devices to the server computer. In some embodiments, the digital content may be automatically retrieved from the one or more user devices and/or transmitted to the server computer.

Further, the method 1400 may include a step 1408 of saving the received digital content in conjunction with associated tracking data received from the one or more user devices. For instance, the user of the online platform 100 may travel to one or more locations with the one or more stones associated with the user profiles of the user. Further, the one or more users may capture digital content such as one or more pictures, videos, and text documents such as blogs associated with the one or more travels undertaken by the one or more users. The captured digital content may correspond to certain associated tracking data such as location, and time, received from the one or more user devices that may indicate the location and time when the digital content may have been captured. Accordingly, the received digital content in may be saved in conjunction with associated tracking data received from the one or more user devices.

Further, the method 1400 may include a step 1410 of displaying the journey of the one or more stones on a map and creating a journal including the received digital content and associated data. The journey of the one or more stones may be created from associated tracking data including the location, and the time of receiving the associated data. For instance, the journey may be displayed by connecting one or more locations that may have been visited by the user with the stone, along with the time at which the user may have visited the one or more locations. Further, a journal may be created displaying the received digital content in the form of a chronological timeline and illustrating one or more locations that may have been visited by the user.

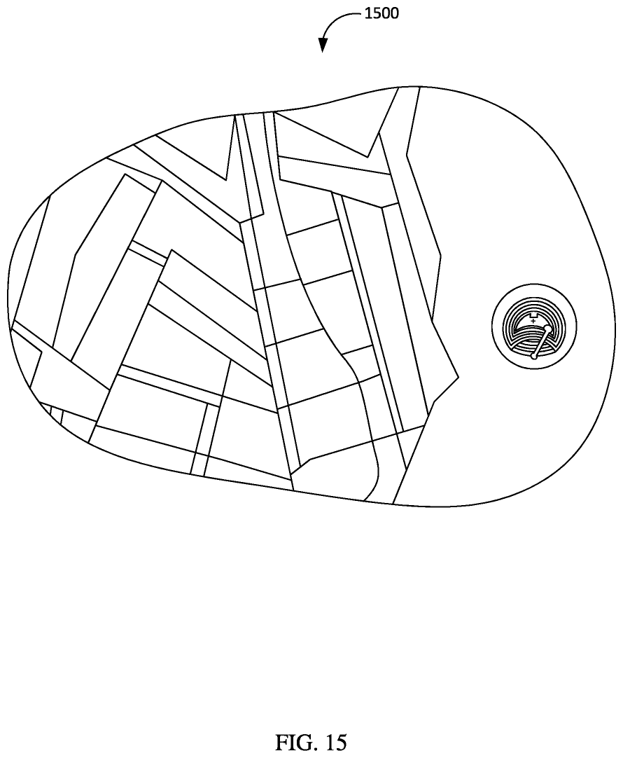

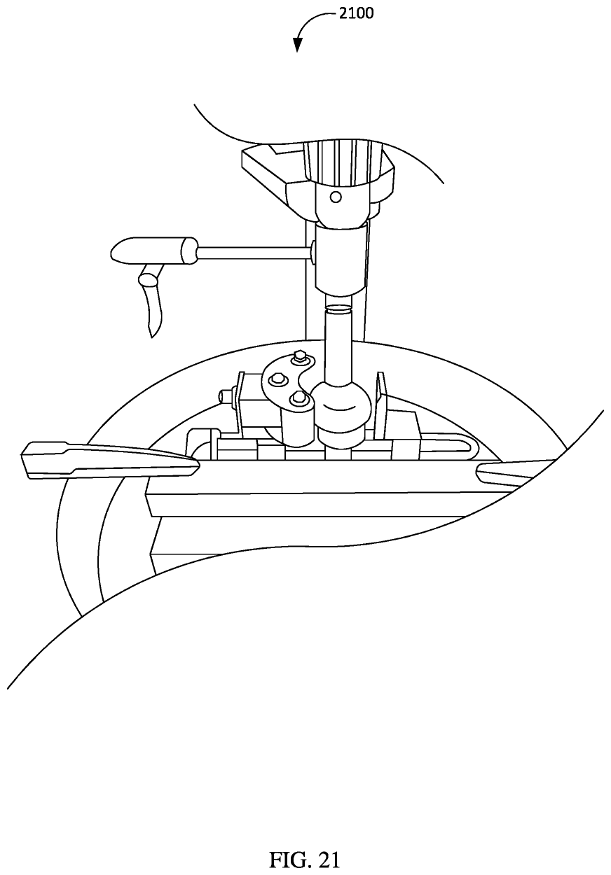

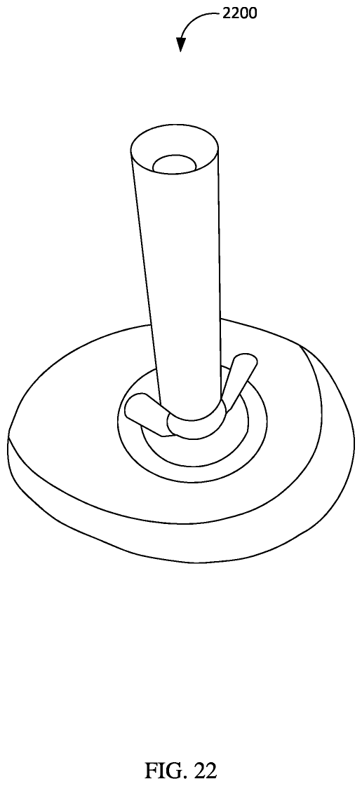

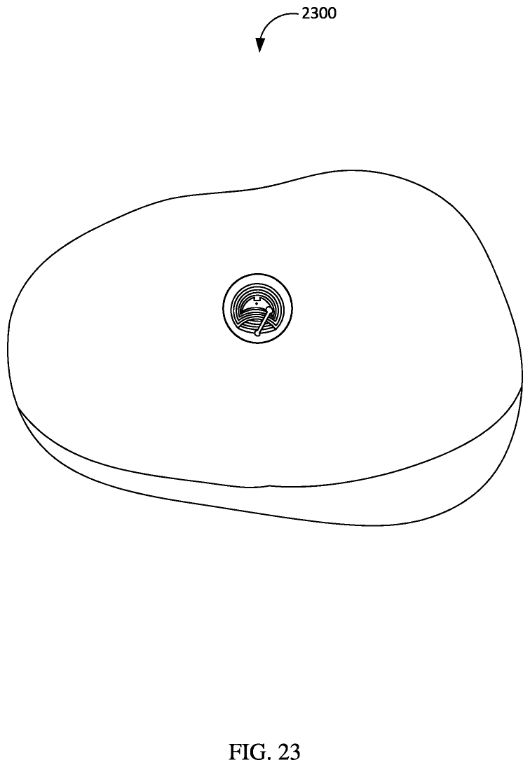

FIG. 15 is a top view of a stone 1500 associated with the disclosed system for facilitating tracking the location of a physical object to display a journey of the physical object on a map in the form of a journal, in accordance with some embodiments. Accordingly, the location of the stone 1500 may be tracked, and the corresponding journey may be displayed in the form of a journal. The stone 1500 may be a smooth beach or river stones imprinted with one or more images to increase the aesthetic appeal of the stone 1500. For instance, the one or more images may include a map of a location. Further, the one or more images may include other types of imagery or decoration such as patterns, symbols or photographs. The stone 1500 may include one or more embedded sensors or tags such as a serial number, NFC tag, RFID tag, and so on. The one or more tags, such as the NFC tag may contain data such as a unique identifier or a serial number of the stone 1500, and a virtual address to a particular database, such as the URL of a web site. A user of the system may register the stone 1500 on the virtual database with the one or more identifiers and on and add personal information, digital content, and media, through one or more connected user devices such as a mobile device. The location of the stone 1500 may be geo-tracked through the one or more connected user devices each time the virtual database, such as the website may be accessed through the one or more connected user devices. Accordingly, if a user registers a stone (such as the stone 1500) on the virtual database and accesses the virtual database with the one or more connected user devices the physical location of the one or more connected user devices may be tracked logged. Further, the location may be stored and pinned on a virtual map. Further, the user of the system may be able to post digital content such as pictures, videos, etc. on the virtual database, which may be saved and displayed in the form of a journal along with the one or more locations as tracked through the one or more connected user devices. Further, the stone 1500 may be transferred to one or more users e.g. as a gift to one or more individuals from other locations. Accordingly, the one or more users may be able to add new digital content at new locations, which may be added to the journal. Further, all users connected to the stone 1500 may receive a notification on a location update and may be able to visit the virtual database to view the updated journal and view the digital content added. Further, the physical dimensions and visual illustrations of the stone 1500 may vary. For instance, the stone 1500 may be a small handheld stone or even a larger stone or boulder. Further, the stone 1500 may be manufactured with an elaborate process. For instance, the process may include the drilling of the stone 1500. A depression blind may be drilled into a surface of the stone 1500 using an appropriate apparatus, as shown in FIG. 21. For instance, a one two-stepped diamond drill bit may be used to make the depression. Alternatively, two separate diamond drill-bits of different diameters may be used in sequence, with a smaller diameter depression used during the production process to hold a keep-nut for attachment of a handle and production tag, and a larger diameter depression being used for embedding one or more tags such in the stone 1500. Further, the stone 1500 may be cleaned and primed by applying a clear, white, or colored primer suitable for the transfer process. Further, one or more visualizations may be reverse printed onto an appropriate PVA film using a high-resolution pigment-based inkjet printer. Further, a hydrographic dipping process may be used to one or more visualizations onto the stone 1500. Further, the imprinted surface of the stone 1500 may be clear coated using a hard finish UV protective coating. The clear coatings may be ceramic-based, such as Cerakote other clear coatings as appropriate to provide UV protection. Further, the one or more tags may be inserted, and a protective acrylic disc may be pressure fitted, as shown in FIG. 22, or glued, to seal the opening and protect the one or more tags, as shown in FIG. 23.

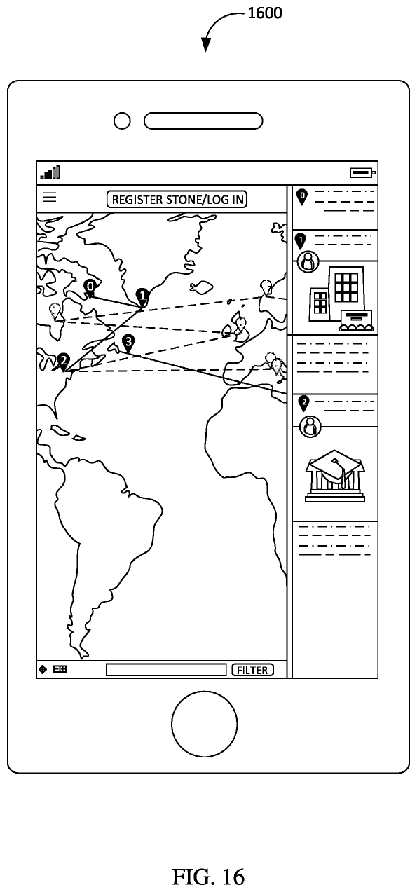

FIG. 16 is a screenshot of a user interface 1600 of a software platform associated with the system to facilitate tracking the location of a physical object to display a journey of the physical object on a map in the form of a journal, in accordance with some embodiments. One or more users of the system may be able to access the user interface 1600 and register on a virtual database along with one or more stones, geo-locate the one or more stones, and share messages and content with other one or more users. Further, the one or more users may be able to explore public journals shared by one or more users, review the one or more journals, stories and media, and search one or more journals or users through one or more specific keywords. Accordingly, the user interface 1600 shows an exemplary journal of a user, displaying the multiple locations visited by the user. Further, the user interface 1600 shows the digital content, such as one or more images or videos shared by the user at the one or more locations. The digital content such as the one or more pictures, videos, and text documents such as blogs may have been captured by the user through one or more user devices and may be associated with one or more travels undertaken by the users.

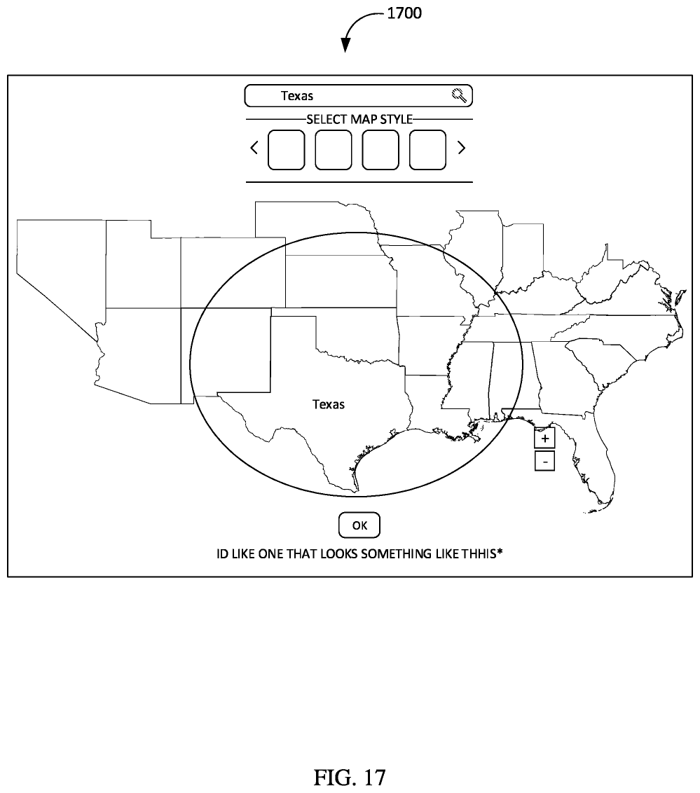

FIG. 17 is a screenshot of a user interface 1700 of the software platform of the system to facilitate tracking the location of a physical object to display a journey of the physical object on a map in the form of a journal, in accordance with some embodiments. Further, the user interface 1700 may enable a user to customize one or more visualizations on a stone. A user may be able to add any type of visualization on a stone. For instance, if the user wishes to add a visualization of a map, the user may be able to the map of any region. The user may be able to choose the preferred size of the stone from a pick list, select a preferred visualization, modify the preferred visualization, select a theme for the visualization, and commission the production. Further, the user may be able to pay for the stone through one or more connected mechanisms. Additional visualization styles may be added the user may be able to make use of one or more visualizations used by one or more other users.

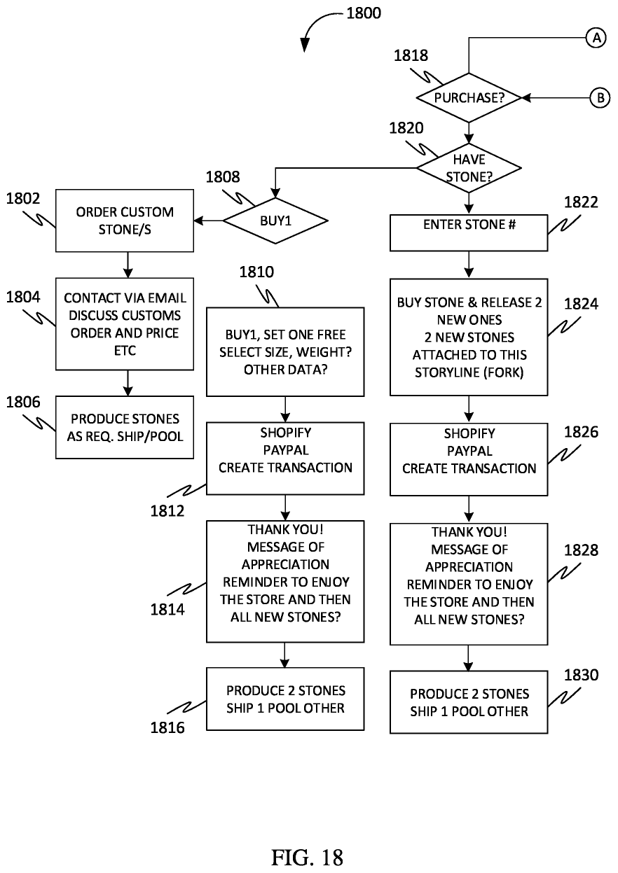

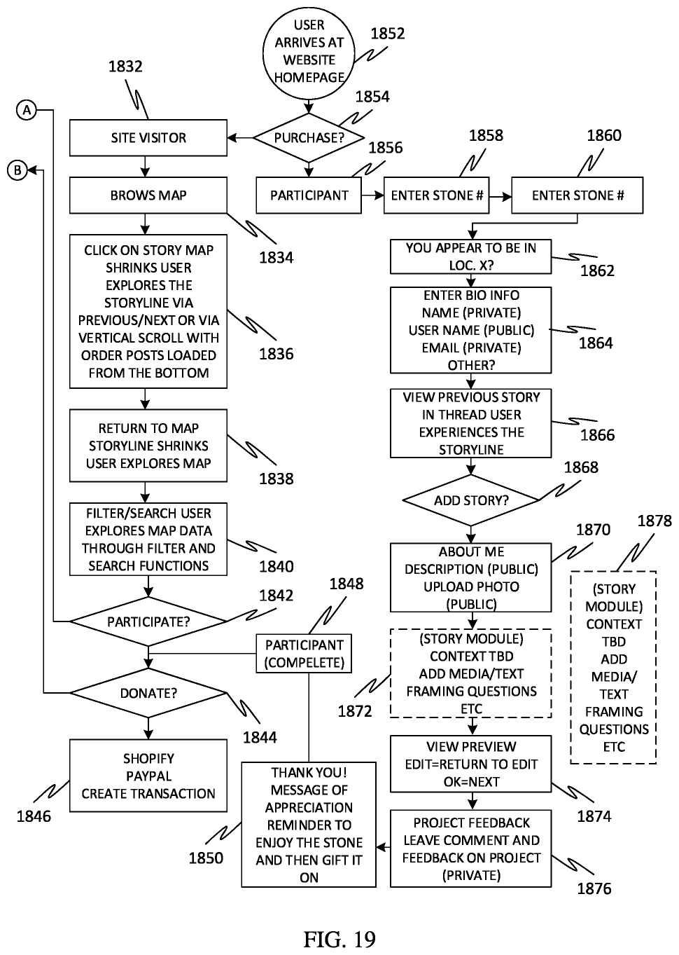

FIG. 18 is a flow diagram of a method 1800 to facilitate tracking the location of a physical object to display a journey of the physical object on a map in the form of a journal, in accordance with some embodiments. FIG. 19 is a continuation flow diagram of FIG. 18. Accordingly, at 1852, the method 1800 may include a user arriving at a website's homepage. Further, at 1854, the method 1800 may include checking a purchase. Further, at 1856, the method 1800 may include a participant. Further, at 1858, the method 1800 may include entering a stone number. Further, at 1860, the method 1800 may include entering the stone number. Further, at 1862, the method 1800 may include checking if the user is in LOC. Further, at 1864, the method 1800 may include entering bio info. Further, at 1866, the method 1800 may include viewing a previous story. Further, at 1868, the method 1800 may include confirming to add story. Further, at 1870, the method 1800 may include receiving about my description and upload photos. Further, at 1872, the method 1800 may include receiving story module. Further, at 1878, the method 1800 may include adding media/text, framing questions using the story module. Further, at 1874, the method 1800 may include viewing preview. Further, at 1876, the method 1800 may include receiving a project feedback. Further, at 1850, the method 1800 may include presenting a “thank you1” message. Further, after 1854, at 1832, the method 1800 may include a site visitor. Further, at 1834, the method 1800 may include the site visitor browsing a map. Further, at 1836, the method 1800 may include clicking on a story map. Further, at 1838, the method 1800 may include returning to the map. Further, at 1840, the method 1800 may include filtering or searching map data. Further, at 1842, the method 1800 may include checking participation. Further, at 1844, the method 1800 may include confirming the donation. Further, at 1846, the method 1800 may include creating transactions. Further, after 1842, at 1848, the method 1800 may include checking complete participation. Further, now the user has the stone and has posted the story. Further, the method 1800 may include sending email to a previous poster (all previous posters?) to inform of a new post in the storyline, sending email reminders after x weeks to gift the stone on. Further, in an instance, the user has the stone, has entered bio info, but not posted story. Further, the method 1800 may include allowing people to only post location, no story, and sending email reminders after x days post story. Further, at 1850, the method 1800 may include presenting a “thank youl” message. Further, after 1842, at 1818, the method 1800 may include confirming a purchase. Further, after 1844, the method 1800 may proceed to 1818. Further, at 1820, the method 1800 may include checking if the user has a stone. Further, at 1822, the method 1800 may include entering the stone number. Further, at 1824, the method 1800 may include buying the stone and releasing 2 new stones. Further, at 1826, the method 1800 may include creating transactions. Further, at 1828, the method 1800 may include presenting a “thank youl” message. Further, at 1830, the method 1800 may include producing 2 stones. Further, the method 1800 may include entering two numbers into the database, emailing the purchaser when the two rocks are released (with details), allowing the poster to enter data into the initial storyline for these new stones, and sending email to previous posters to inform of a fork. Further, after 1820, at 1808, the method 1800 may include buying one stone. Further, at 1802, the method 1800 may include ordering custom stones. Further, at 1804, the method 1800 may include contacting via email. Further, at 1806, the method 1800 may include producing stones as required. Further, the method 1800 may include entering numbers into the database. Further, the method 1800 may include checking if the poster is allowed to enter data into the initial storyline for all new stones. Further, at 1810, the method 1800 may include buying one set. Further, at 1812, the method 1800 may include creating transactions. Further, at 1814, the method 1800 may include presenting a “thank you!” message. Further, at 1816, the method 1800 may include producing 2 stones. Further, the method 1800 may include entering two numbers into the database. Further, the method 1800 may include emailing the purchaser when the two rocks are released (with details). Further, the method 1800 may include allowing the poster to enter data into the initial storyline for these new stones. Further, the method 1800 may include a step of a user arriving at the online platform to purchase a stone, or to register a user account. Accordingly, the user may create the account by entering the necessary information such as a stone number. Further, the location of the user may be retrieved, and the user may be prompted to upload digital content such as one or more pictures or videos to the journal of the user. Further, the user may be prompted to add personal information such as name, email address, and so on. Further, the user may choose to view one or more journals, and if has received the stone as a gift, view previous entries in the journal. Further, the user may be able to leave comments or feedback. Further, the method 1800 may include a step of notifying the previous owner of the stone that the new user may have registered on the online platform. Alternatively, if the user wishes to purchase a stone, the user may be able to select a stone from a list of pre-created stones and order a stone. Further, if the user wishes to create a custom stone, the user may customize a stone according to preferences, and order the stone. Further, if the user has a stone, the user may enter information such as the stone number, and buy new stones attached to a journal of the current stone. Accordingly, the user may be able to order one or more stones and be able to fork the journal associated with the stone.

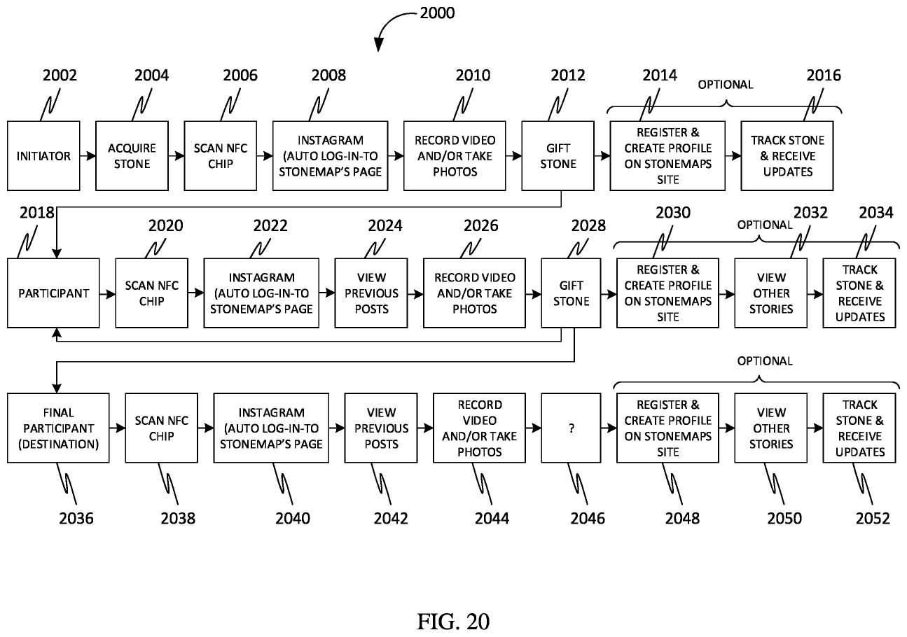

FIG. 20 is a flow diagram of a method 2000 to facilitate tracking the location of a physical object to display a journey of the physical object on a map in the form of a journal, in accordance with some embodiments. Accordingly, at 2002, the method 2000 may include an initiator. Further, at 2004, the method 2000 may include acquiring store. Further, at 2006, the method 2000 may include scanning an NFC chip. Further, at 2008, the method 2000 may include Instagram auto-login to stonemap's page. Further, at 2010, the method 2000 may include recording video. Further, at 2012, the method 2000 may include gifting stone. Further, at 2014, the method 2000 may include registering and creating a profile. Further, at 2016, the method 2000 may include tracking stone and receiving updates. Further, after 2012, at 2018, the method 2000 may include a participant. Further, at 2020, the method 2000 may include scanning the NFC chip. Further, at 2022, the method 2000 may include Instagram auto login to stonemap's page. Further, at 2024, the method 2000 may include viewing previous posts. Further, at 2026, the method 2000 may include recording video or taking photos. Further, at 2028, the method 2000 may include gifting stone. Further, at 2030, the method 2000 may include registering and creating a profile. Further, at 2032, the method 2000 may include viewing other stories. Further, at 2034, the method 2000 may include tracking stone and receiving updates. Further, after 2028, at 2036, the method 2000 may include a final participant. Further, at 2038, the method 2000 may include scanning the NFC chip. Further, at 2040, the method 2000 may include Instagram auto login to stonemap's page. Further, at 2042, the method 2000 may include viewing previous posts. Further, at 2044, the method 2000 may include recording video and taking photos. Further, at 2046, the method 2000 may include checking if it is defined by the initiator. Further, the method 2000 may include checking if a stone is sent back to stonemaps. Further, the method 2000 may include checking if the stone is sent back to initiator. Further, the method 2000 may include checking if stonemap is kept. Further, the method 2000 may include checking if stonemaps are flagged as “arrived”. Further, the method 2000 may include opening a direct contact between in initiator and final recipient and awaiting contact or more instructions from the initiator. Further, at 2048, the method 2000 may include registering and creating a profile. Further, at 2050, the method 2000 may include viewing other stories. Further, at 2052, the method 2000 may include tracking the stone and receiving updates.

Further, the method 2000 may include a step of acquiring a stone by a user of the system. The user may scan the one or more tags in the stone, and log in to the system through an externally connected social-media login mechanism. Further, the user may be able to upload digital content such as images or videos. Further, the user may be able to register on the system and track the journey of the stone. Further, the method 2000 may include a step of presenting the stone to another user. The user may scan the one or more tags in the stone, and log in to the system through an externally connected social-media login mechanism. Further, the user may be able to upload digital content such as images or videos. Further, the user may be able to register on the system and track the journey of the stone. Accordingly, the process of presenting the stone to one or more other users may continue indefinitely. The one or more other users may be able to register on the system and track the journey of the stone.

FIG. 21 illustrates an apparatus 2100 drilling the depression into a surface of the stone, in accordance with some embodiments.

FIG. 22 illustrates an apparatus 2200 for inserting tags and protective acrylic disc in the stone, in accordance with some embodiments.

FIG. 23 is a top view of a stone 2300 with tags and protective acrylic disc, in accordance with some embodiments. Accordingly, the protective acrylic disc may be pressure fitted or glued to seal the opening and protect the one or more tags.

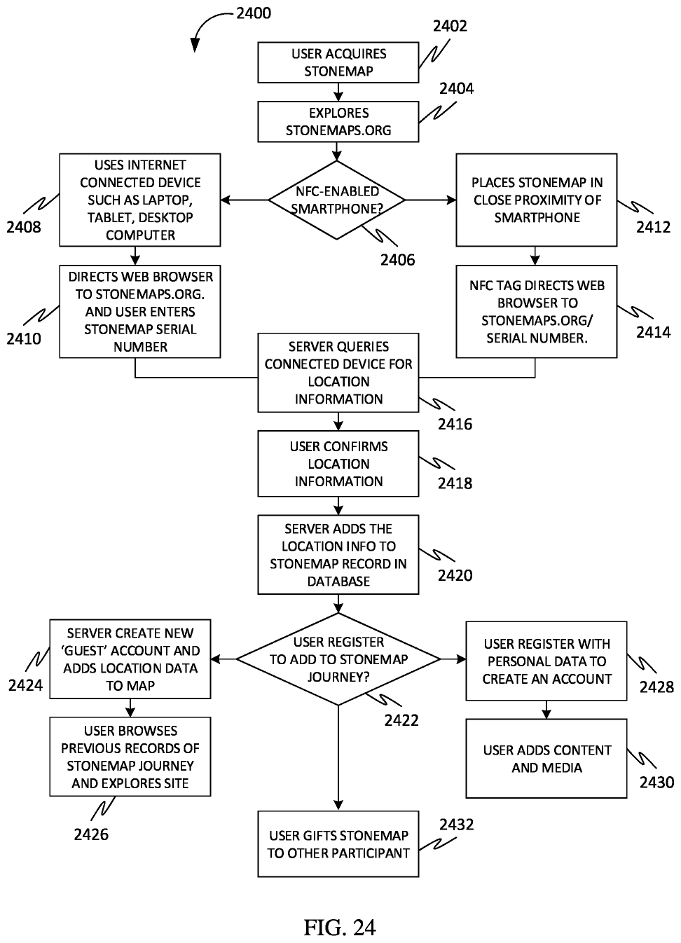

FIG. 24 is a flow diagram of a method 2400 to facilitate tracking the location of a physical object to display a journey of the physical object on a map in the form of a journal, in accordance with some embodiments. Further, at 2402, the method 2400 may include a user acquiring a stonemap. Further, at 2404, the method 2400 may include exploring stonemaps.org. Further, at 2406, the method 2400 may include checking for NFC-enabled smartphones. Further, at 2412, the method 2400 may include placing the stonemap in close proximity to a smartphone. Further, at 2414, the method 2400 may include an NFC tag directing a web browser to stonemaps.org. Further, at 2416, the method 2400 may include server querying connected devices. Further, at 2418, the method 2400 may include a user confirming location information. Further, at 2420, the method 2400 may include the server adding the location information. Further, at 2422, the method 2400 may include checking if the user registers to add to the stonemap's journey. Further, at 2428, the method 2400 may include the user registering with personal data to create an account. Further, at 2430, the method 2400 may include adding content and media by the user. Further, after 2422, at 2428, the method 2400 may include the user gifting the stonemap to other participants. Further, after 2422, at 2424, the method 2400 may include the server creating a new guest account. Further, at 2426, the method 2400 may include the user browsing previous records of the stonemap's journey. Further, after 2406, at 2408, the method 2400 may include using an internet-connected device. Further, at 2410, the method 2400 may include directing a web browser to stonemaps.org. Further, after 2410, the method 2400 may proceed to 2416.

Accordingly, the method 2400 may include a step of acquiring a stone by a user of the system. If the user has an NFC-enabled smartphone, the user may place the smartphone in close proximity of the stone and access the system. Alternatively, the user may enter the serial number of the stone, and log in to the system. Further, the location of the user may be retrieved from a sensor in the user device, and the user may confirm the location. Accordingly, the location of the user may be saved in a database. Further, the user may register on the system, and proceed to upload digital content and media. Alternatively, a guest account may be created for the user and the user may be able to upload digital content, and media, which may be saved along with information particular to the stone, such as the serial number. Further, the user may present the stone to another individual. Accordingly, the process of gifting the stone to one or more other users may continue indefinitely. The one or more other users may be able to register on the system and track the journey of the stone.

Although the present disclosure has been explained in relation to its preferred embodiment, it is to be understood that many other possible modifications and variations can be made without departing from the spirit and scope of the disclosure.

### REFERENCES

[1] Emily Singer. The Measured Life. MIT Technology Review, 2011(7), July 2011.

[2] Yuval Noah Harari. Homo Deus: A Brief History of Tomorrow. Signal, October 2017.

[3] Nicholas Carr. The Shallows: What The Internet Is Doing To Our Brains. WWNorton, New York, reprint edition edition, June 2011.

[4] Adam Alter. Irresistible: The Rise of Addictive Technology and the Business of Keeping Us Hooked. Penguin Press, New York, March 2017.

[5] Tristan Harris. Tristan Harris. https://www.tristanharris.com.

[6] Sherry Turkle. Alone Together: Why We Expect More from Technology and Less from Each Other. Basic Books, 3 edition edition, November 2017.

[7] Jack Dorsey. How Twitter needs to change. TED2019, Vancouver BC, CANADA, April 2019.

[8] Shoshana Zuboff. The Age of Surveillance Capitalism: The Fight for a Human Future at the New Frontier of Power. PublicAffairs, New York, 1 edition edition, January 2019.

[9] Benedikt Köhler, Sabria David, and Jörg Blumtritt. The Slow Media Manifesto—Slow Media, January 2010.

[10] Jennifer Rauch. Slow Media: Why Slow is Satisfying, Sustainable, and Smart. Oxford University Press, New York, N.Y., September 2018.

[11] Jenny Odell. How to Do Nothing: Resisting the Attention Economy. Melville House, Brooklyn, N.Y., April 2019.

[12] Robin Sloan. Thread by robin on Rosegarden, July 2019. https://platforms.fyi.

[13] The P2P Foundation, 2005. https://p2pfoundation.net/.

[14] Michel Bauwens. Michel Bauwens on the Commons & on systemic, organizational, personal transformation, April 2018. https://www.youtube.com/watch?v=GVgZczNFcpE.

[15] Jane Bennett. Vibrant Matter: A Political Ecology of Things. Duke University Press, December 2009.

[16] Jane Bennett. The Enchantment of Modern Life: Attachments, Crossings, and Ethics. Princeton University Press, Princeton, N.J., September 2001.

[17] Lee Mingwei. The Moving Garden. Biennale de Lyon, 2009. Stainless steel, granite, water, fresh flowers.

[18] Lewis Hyde. The Gift: Imagination and the Erotic Life of Property. Vintage, New York, 1st vintage books ed edition edition, February 1983. [19] Marcel Mauss and E. E. Evans-Pritchard. The Gift: Forms and Functions of Exchange in Archaic Societies. Martino Fine Books, Mansfield Centre, CT, April 2011.

[20] Robin McKenna. Gift, March 2018. IMDb ID: tt4276094.

[21] Brian A. Stewart, Yuchao Zhao, Peter J. Mitchell, Genevieve Dewar, James D. Gleason, and Joel D. Blum. Ostrich eggshell bead strontium isotopes reveal persistent macroscale social networking across late Quaternary southern Africa. Proceedings of the National Academy of Sciences, March 2020.

[22] Mark S. Granovetter. The Strength of Weak Ties. American Journal of Sociology, 78(6):1360-1380, 1973.

[23] Sinan Aral and Marshall Van Alstyne. The Diversity-Bandwidth Trade-off American Journal of Sociology, 117(1):90-171, July 2011.

[24] Elinor Ostrom. Governing the Commons: The Evolution of Institutions for Collective Action. Cambridge University Press, Cambridge, United Kingdom, reissue edition, September 2015.

[25] Craig S. Smith. Building a World Where Data Privacy Exists Online. The New York Times, November 2019.

What is claimed is:

1. A method for facilitating documenting journeys of physical objects, the method comprising:
receiving, using a communication device, at least one identifier associated with at least one physical object from at least one device, wherein the at least one device comprises at least one scanning device, wherein the at least one scanning device is configured for generating the at least one identifier based on scanning at least one tag embedded in the at least one physical object;
identifying, using a processing device, the at least one physical object based on the at least one identifier;
retrieving, using a storage device, at least one physical object historical data associated with the at least one physical object based on the identifying, wherein the at least one physical object historical data comprises at least one historical tracking data and at least one historical digital content;
receiving, using the communication device, at least one physical object data associated with the at least one physical object from the at least one device, wherein the at least one physical object data comprises at least one tracking data and at least one digital content;
analyzing, using the processing device, at least one of the at least one physical object data and the at least one physical object historical data;
determining, using the processing device, at least one tracking parameter for tracking a journey by the at least one physical object based on the analyzing;
generating, using the processing device, at least one journal of the at least one physical object using at least one of the at least one physical object data and the at least one physical object historical data based on the at least one tracking parameter, wherein the at least one journal documents the journey of the at least one physical object; and
storing, using the storage device, the at least one physical object data and the at least one journal.

2. The method of claim 1 further comprising arranging, using the processing device, at least one of the at least one digital content and the at least one historical content based on the at least one tracking parameter, wherein the generating of the at least one journal is further based on the arranging.

3. The method of claim 1, wherein the at least one tracking parameter comprises at least one location of the at least one physical object, wherein the method further comprises plotting, using the processing device, at least one path traveled by the at least one physical object on at least one map based on the at least one location, wherein the generating of the at least one journal is further based on the plotting.

4. The method of claim 1, wherein the at least one device comprises at least one sensor, wherein the at least one sensor is embedded in the at least one physical object, wherein the at least one sensor is configured for generating at least one location data of the at least one physical object based on a location of the at least one physical object at a time, wherein the at least one tracking data comprises the at least one location data.

5. The method of claim 1, wherein the at least one physical object is owned by a current owner, wherein the method further comprises:
determining, using the processing device, an intent associated with the journey the at least one physical object based on the analyzing of the at least one physical object historical data;
generating, using the processing device, at least one recommendation for at least one of the at least one physical object data and a next owner of the at least one physical object based on the determining of the intent; and
transmitting, using the communication device, the at least one recommendation to the at least one device.

6. The method of claim 1 further comprising:
receiving, using the communication device, at least one physical object information associated with the at least one physical object from at least one current owner device associated with a current owner of the at least one physical object; and
registering, using the processing device, the at least one physical object for the documenting of the journey of the at least one physical object based on the at least one physical object information.

7. The method of claim 6 further comprising:
analyzing, using the processing device, the at least one physical object information associated with the at least one physical object;
determining, using the processing device, an intent associated with the journey of the at least one physical object based on the analyzing of the at least one physical obj ect data;
generating, using the processing device, at least one recommendation for at least one of the at least one physical object data and a next owner of the at least one physical object based on the determining of the intent; and
transmitting, using the communication device, the at least one recommendation to the at least one device.

8. The method of claim 1 further comprising:
receiving, using the communication device, an ownership transfer request for transferring an ownership of the at least one physical object from a current owner of the at least one physical object to a next owner of the at least one physical object from at least one current owner device associated with the current owner, wherein the ownership transfer request comprises at least one next owner identifier associated with the next owner, wherein the transferring of the ownership forms a network between the current owner and the next owner;
associating, using the processing device, the next owner with the at least one physical obj ect using the at least one next owner identifier based on the ownership transfer request, wherein the associating makes the next owner a member of the network associated with the journey of the at least one physical object;
generating, using the processing device, an ownership acknowledgment of the ownership of the at least one physical object based on the associating; and
transmitting, using the communication device, the ownership acknowledgment to one or more devices associated with one or more members associated with the network.

9. The method of claim 1, wherein the at least one device comprises at least one capturing device, wherein the at least one capturing device is configured for capturing the at least one physical object data associated with the at least one physical object.

10. The method of claim 1, wherein the retrieving of the at least one physical object historical data comprises retrieving the at least one physical object historical data from a distributed ledger, wherein the storing of the at least one physical object data and the at least one journal comprises storing the at least one physical object data and the at least one journal in the distributed ledger.

11. A system for facilitating documenting journeys of physical objects, the system comprising:
a communication device configured for:
receiving at least one identifier associated with at least one physical object from at least one device, wherein the at least one device comprises at least one scanning device, wherein the at least one scanning device is configured for generating the at least one identifier based on scanning at least one tag embedded in the at least one physical object; and
receiving at least one physical object data associated with the at least one physical object from the at least one device, wherein the at least one physical object data comprises at least one tracking data and at least one digital content;
a processing device communicatively coupled with the communication device, wherein the processing device is configured for:
identifying the at least one physical object based on the at least one identifier;
analyzing at least one of the at least one physical object data and at least one physical object historical data;
determining at least one tracking parameter for tracking a journey by the at least one physical object based on the analyzing; and
generating at least one journal of the at least one physical object using at least one of the at least one physical object data and the at least one physical object historical data based on the at least one tracking parameter, wherein the at least one journal documents the journey of the at least one physical object; and
a storage device communicatively coupled with the processing device, wherein the storage device is configured for:
retrieving the at least one physical object historical data associated with the at least one physical object based on the identifying, wherein the at least one physical object historical data comprises at least one historical tracking data and at least one historical digital content; and
storing the at least one physical object data and the at least one journal.

12. The system of claim 11, wherein the processing device is further configured arranging at least one of the at least one digital content and the at least one historical content based on the at least one tracking parameter, wherein the generating of the at least one journal is further based on the arranging.

13. The system of claim 11, wherein the at least one tracking parameter comprises at least one location of the at least one physical object, wherein the processing device is further configured for plotting at least one path traveled by the at least one physical object on at least one map based on the at least one location, wherein the generating of the at least one journal is further based on the plotting.

14. The system of claim 11, wherein the at least one device comprises at least one sensor, wherein the at least one sensor is embedded in the at least one physical object, wherein the at least one sensor is configured for generating at least one location data of the at least one physical object based on a location of the at least one physical object at a time, wherein the at least one tracking data comprises the at least one location data.

15. The system of claim 11, wherein the at least one physical object is owned by a current owner, wherein the processing device is further configured for:
determining an intent associated with the journey the at least one physical object based on the analyzing of the at least one physical object historical data; and
generating at least one recommendation for at least one of the at least one physical object data and a next owner of the at least one physical object based on the determining of the intent, wherein the communication device is further configured for transmitting the at least one recommendation to the at least one device.

16. The system of claim 11, wherein the communication device is further configured for receiving at least one physical object information associated with the at least one physical object from at least one current owner device associated with a current owner of the at least one physical object, wherein the processing device is further configured for registering the at least one physical object for the documenting of the journey of the at least one physical object based on the at least one physical object information.

17. The system of claim 16, wherein the processing device is further configured for:
analyzing the at least one physical object information associated with the at least one physical object;
determining an intent associated with the journey of the at least one physical object based on the analyzing of the at least one physical object data; and
generating at least one recommendation for at least one of the at least one physical object data and a next owner of the at least one physical object based on the determining of the intent, wherein the communication device is further configured for transmitting the at least one recommendation to the at least one device.

18. The system of claim 11, wherein the communication device is further configured for:
receiving an ownership transfer request for transferring an ownership of the at least one physical object from a current owner of the at least one physical object to a next owner of the at least one physical object from at least one current owner device associated with the current owner, wherein the ownership transfer request comprises at least one next owner identifier associated with the next owner, wherein the transferring of the ownership forms a network between the current owner and the next owner; and
transmitting an ownership acknowledgment to one or more devices associated with one or more members associated with the network, wherein the processing device is further configured for:
associating the next owner with the at least one physical object using the at least one next owner identifier based on the ownership transfer request, wherein the associating makes the next owner a member of the network associated with the journey of the at least one physical object; and
generating the ownership acknowledgment of the ownership of the at least one physical object based on the associating.

19. The system of claim 11, wherein the at least one device comprises at least one capturing device, wherein the at least one capturing device is configured for capturing the at least one physical object data associated with the at least one physical object.

20. The system of claim 11, wherein the retrieving of the at least one physical object historical data comprises retrieving the at least one physical object historical data from a distributed ledger, wherein the storing of the at least one physical object data and the at least one journal comprises storing the at least one physical object data and the at least one journal in the distributed ledger.
